(19) United States
(12) Patent Application Publication
(10) Pub. No.: US 2026/0059034 A1
(43) Pub. Date: Feb. 26, 2026

(54) ELECTRONIC DEVICE INCLUDING DRIVING MOTOR

(71) Applicant: Samsung Electronics Co., Ltd., Suwon-si (KR)

(72) Inventors: Sungho KIM, Suwon-si (KR); Hyunggwang KANG, Suwon-si (KR); Taewook KWON, Suwon-si (KR); Moonsun KIM, Suwon-si (KR); Junghoon SEO, Suwon-si (KR); Changin SONG, Suwon-si (KR); Sungho AHN, Suwon-si (KR); Changhee YOO, Suwon-si (KR); Soyoung LEE, Suwon-si (KR)

(21) Appl. No.: 19/324,698

(22) Filed: Sep. 10, 2025

Related U.S. Application Data
(63) Continuation of application No. PCT/KR2025/012731, filed on Aug. 21, 2025.

(30) Foreign Application Priority Data
Aug. 21, 2024 (KR) 10-2024-0112228

(51) Int. Cl. H04M 1/02; H02K 7/06; H02K 7/116

(52) U.S. Cl. CPC H04M 1/0237; H02K 7/06; H02K 7/116; H04M 1/0245; H04M 1/0268

(57) ABSTRACT

An electronic device is provided. The electronic device includes a first housing, a second housing configured to move with respect to the first housing, a flexible display disposed between the first housing and the second housing, the flexible display including an internal region that at least partially moves within an internal space of the electronic device based on a movement of the second housing with respect to the first housing, a support member including a first support member supporting an end portion of the internal region of the flexible display and a plurality of second support members supporting a portion of the flexible display excluding the end portion, a motor including a pinion gear and disposed in the first housing, and a rack gear engaged with the pinion gear and having an end coupled to the first support member, wherein the rack gear and the first support member move in a same direction as a moving direction of the first housing with respect to the second housing based on driving of the motor.

### CROSS-REFERENCE TO RELATED APPLICATION(S)

This application is a continuation application, claiming priority under 35 U.S.C. § 365(c), of an International application No. PCT/KR2025/012731, filed on Aug. 21, 2025, which is based on and claims the benefit of a Korean patent application number 10-2024-0112228, filed on Aug. 21, 2024, in the Korean Intellectual Property Office, the disclosure of which is incorporated by reference herein in its entirety.

### TECHNICAL FIELD

The disclosure relates to an electronic device including a driving motor.

### BACKGROUND ART

Electronic devices are gradually becoming slimmer and more rigid, being enhanced in design aspects, and being improved to differentiate functional elements thereof. Electronic devices are gradually evolving from a uniform rectangular shape to diverse shapes. An electronic device may have a transformable structure that is convenient to carry and enables the use of a large-screen display. The electronic device may have a structure capable of making the display area of a flexible display (e.g., a rollable display) variable through supporting by housings that operate in a sliding manner relative to each other (e.g., a rollable structure or a slidable structure). Such an electronic device may require an efficient arrangement structure for peripheral electrical components according to a driving module (e.g., a driving motor and a rack) configured to automatically slide the remaining housing with respect to one housing.

The above information is presented as background information only to assist with an understanding of the disclosure. No determination has been made, and no assertion is made, as to whether any of the above might be applicable as prior art with regard to the disclosure.

### DISCLOSURE OF INVENTION

Aspects of the disclosure are to address at least the above-mentioned problems and/or disadvantages and to provide at least the advantages described below. Accordingly, an aspect of the disclosure is to provide an electronic device including a driving motor.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a second housing configured to move with respect to the first housing, a flexible display disposed between the first housing and the second housing, the flexible display including an internal region that at least partially moves within an internal space of the electronic device based on a movement of the second housing with respect to the first housing, a support member including a first support member supporting an end portion of the internal region of the flexible display and a plurality of second support members supporting a portion of the flexible display excluding the end portion, a motor including a pinion gear and disposed in the first housing, and a rack gear engaged with the pinion gear and having an end portion coupled to the first support member, wherein the rack gear and the first support member move in a same direction as a moving direction of the first housing with respect to the second housing based on driving of the motor.

In accordance with another aspect of the disclosure, an electronic device is provided. The electronic device includes a first housing, a second housing movably coupled to the first housing, a flexible display disposed between the first housing and the second housing, the flexible display including an internal region that at least partially moves within an internal space of the electronic device based on a movement of the second housing with respect to the first housing, a support member including a first support member supporting an end portion of the internal region of the flexible display and a plurality of second support members supporting a portion of the flexible display excluding the end portion, a motor including a pinion gear and disposed in the first housing, and a guide member driven via the pinion gear and having one end coupled to the first support member, wherein the guide member and the first support member move in a same direction as a moving direction of the first housing with respect to the second housing based on driving of the motor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B illustrate front and rear views of an electronic device in a slide-in state according to various embodiments of the disclosure;

FIGS. 3A and 3B illustrate front and rear views of the electronic device in a slide-out state according to various embodiments of the disclosure;

FIG. 4 is an exploded perspective view of an electronic device according to an embodiment of the disclosure;

FIG. 5A is a view illustrating a state in which a rack gear coupled to the first support member supporting a second portion of a flexible display is connected to a pinion gear of a motor, according to an embodiment of the disclosure;

FIG. 5B is a view illustrating a connection relationship among a first support member, a rack gear, and a motor, according to an embodiment of the disclosure;

FIG. 5C is a view illustrating a coupling relationship between the first support member and the rack gear, according to an embodiment of the disclosure;

FIG. 6A is a cross-sectional view of an electronic device taken along line 5a-5a in FIG. 2A according to an embodiment of the disclosure;

FIG. 6B is a cross-sectional view of the electronic device taken along line 5b-5b of FIG. 3A, according to an embodiment of the disclosure;

FIG. 7A is a perspective view illustrating the electronic device in the slide-out state according to an embodiment of the disclosure;

FIG. 7B is a configuration view of the electronic device illustrating the arrangement structure of the motor and the rack gear disposed in the first housing in the slide-out state, according to an embodiment of the disclosure;

FIG. 7C is a configuration view of the electronic device illustrating the arrangement structure of the motor and the rack gear disposed in the first housing in the slide-in state, according to an embodiment of the disclosure;

FIG. 8A is an enlarged view of guide protrusions inserted into a guide rail, according to an embodiment of the disclosure;

FIG. 8B is a cross-sectional view of the electronic device taken along line 8b-8b of FIG. 7B, according to an embodiment of the disclosure;

FIG. 9 is a cross-sectional view of the electronic device taken along line 9-9 of FIG. 7C, according to an embodiment of the disclosure;

FIG. 10 is a diagram illustrating the frictional force between the guide rails and the guide protrusions during the relative movement of the first housing and the second housing, according to an embodiment of the disclosure; and

FIGS. 11A and 11B are views illustrating the connection relationship of a motor, a screw member, and a guide member coupled to a first support member, according to various embodiments of the disclosure.

The same reference numerals are used to represent the same elements throughout the drawings.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

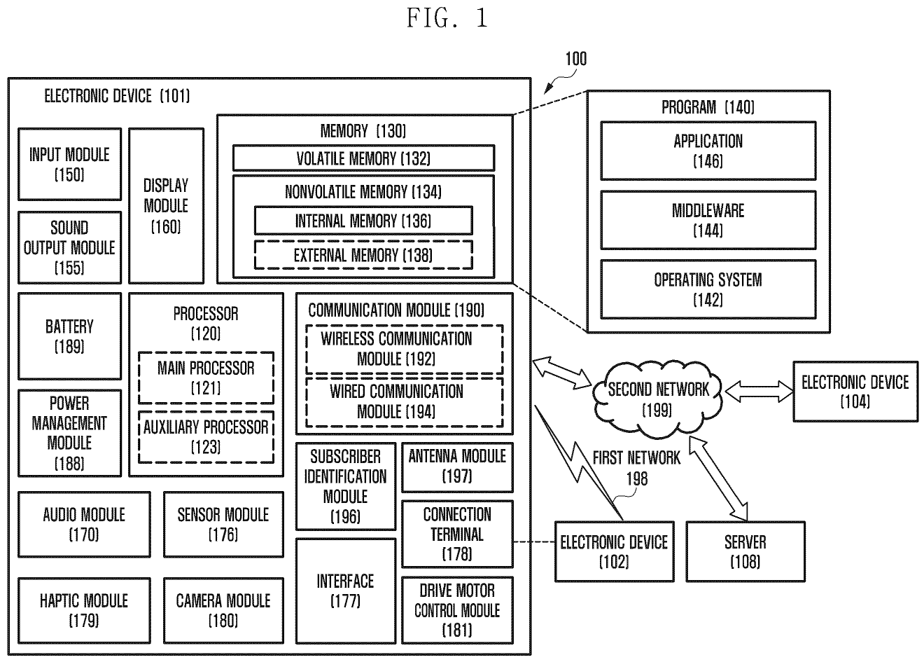

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. The non-volatile memory 134 includes internal memory 136 and may also include external memory 138. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

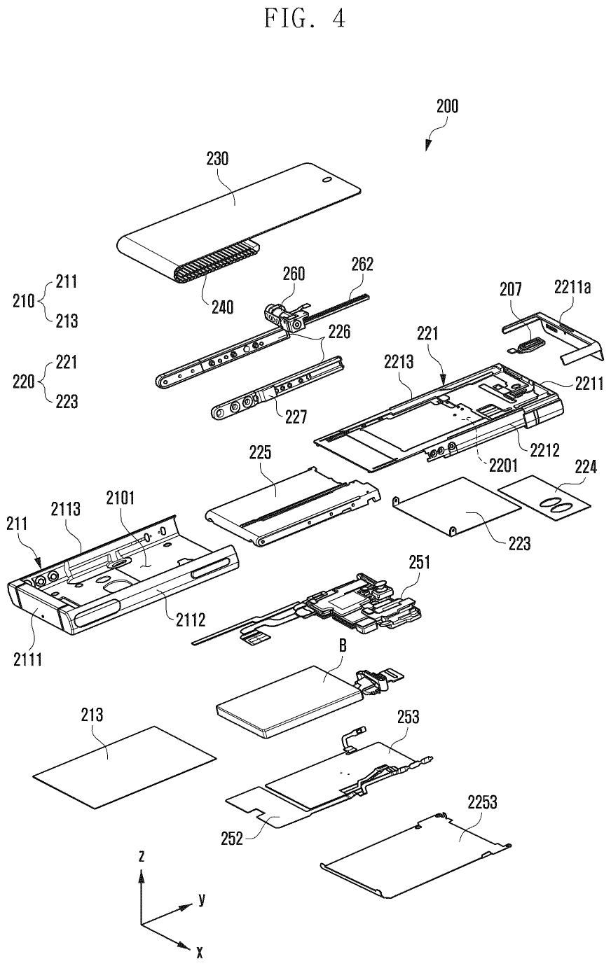

According to various embodiments, the sensor module 176 may include a moving distance detection sensor configured to detect the moving distance of the second housing (e.g., the second housing 220 in FIG. 4) from the first housing (e.g., the first housing 210 in FIG. 4) of an electronic device (e.g., the electronic device 200 in FIG. 4). In an embodiment, the sensor module 176 may detect a first state, which is a slide-in state in which the second housing 220 is fully slid into the first housing 210, a second state, which is a slide-out state in which the second housing is fully slid out from the first housing 210, or an intermediate state between the slide-in state and the slide-out state. In some embodiments, the processor 120 may be configured to detect the moving distance in real time via the sensor module 176 while the second housing 220 is moving from the first housing 210, and to control the display module 160 to display an object corresponding to a changing display area via a flexible display (e.g., the flexible display 230 in FIG. 4). In an embodiment, the electronic device 101 may include a driving motor control module 181 configured to control the operation of a driving motor (e.g., a DC motor or a stepping motor) (e.g., the motor 260 of FIG. 4) disposed inside the electronic device. In some embodiments, the processor 120 may replace the driving motor control module 181.

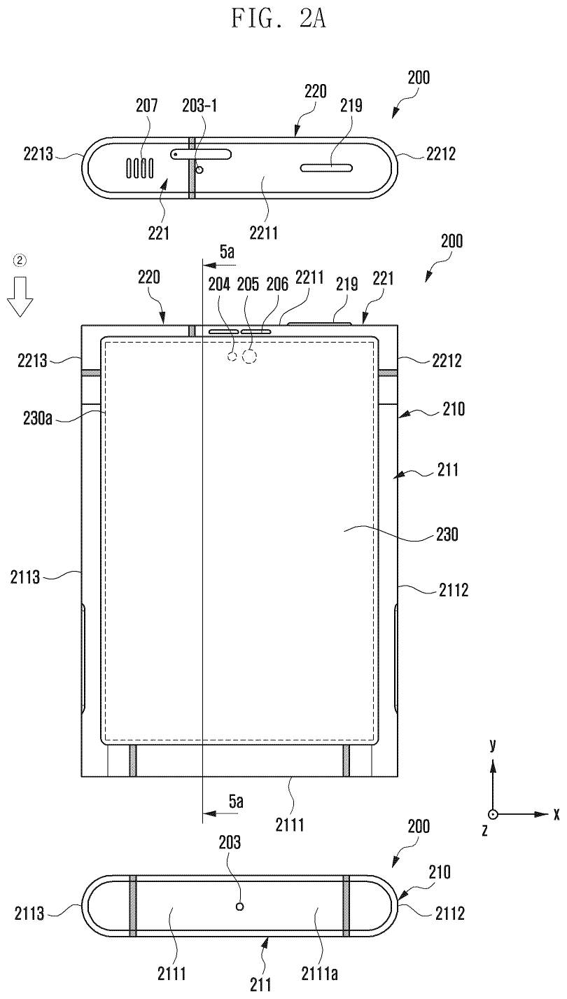

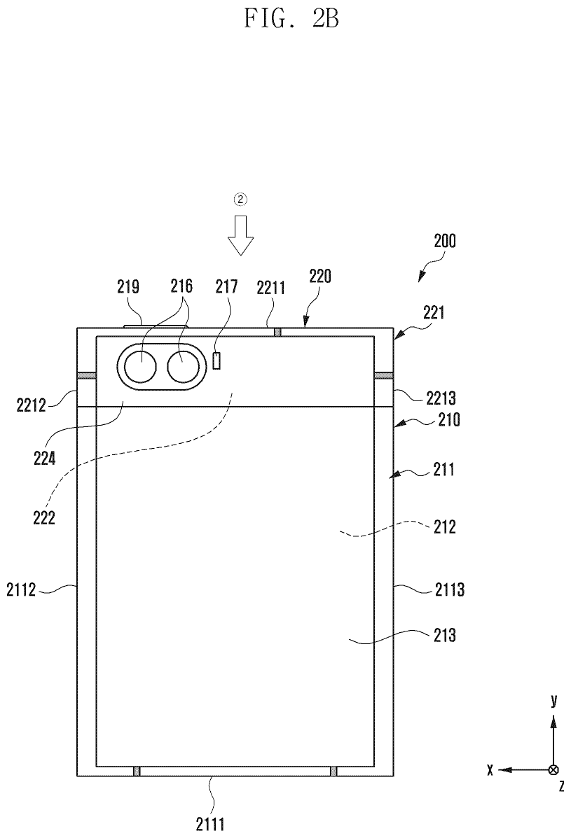

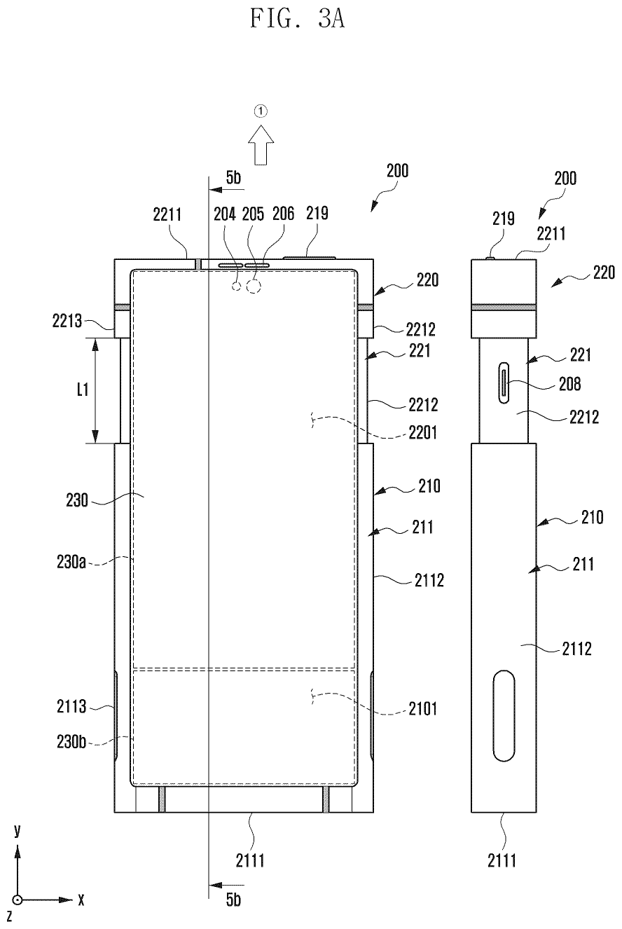

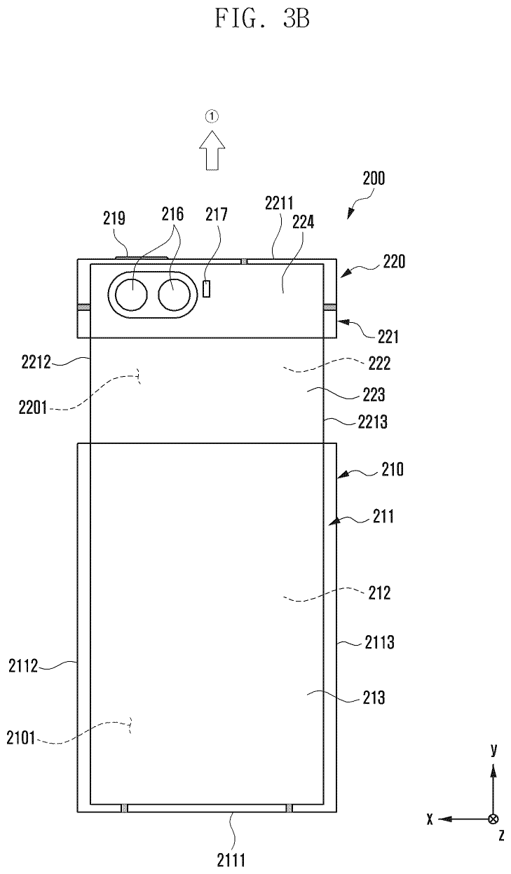

FIGS. 2A and 2B illustrate front and rear views of an electronic device in a slide-in state according to various embodiments of the disclosure. FIGS. 3A and 3B illustrate front and rear views of the electronic device in a slide-out state according to various embodiments of the disclosure.

The electronic device 200 of FIGS. 2A, 2B, 3A, and 3B may be at least partially similar to the electronic device 101 of FIG. 1 or may further include other embodiments of the electronic device.

Referring to FIGS. 2A, 2B, 3A, and 3B, an electronic device 200 may include a first housing 210 (e.g., a book cover or a first housing structure), a second housing 220 (e.g., a front cover or a second housing structure) slidably coupled to the first housing 210 in a predetermined direction (e.g., direction \textcircled{1} or direction \textcircled{2}) (e.g., ±y-axis direction), and a flexible display 230 (e.g., a rollable display, an expandable display, or a stretchable display) disposed to be supported by at least a portion of the first housing 210 and the second housing 220. In an embodiment, the second housing 220 may be slidably coupled to the first housing 210 so as to be slid out along a first direction (direction \textcircled{1}) with respect to the first housing 210 or slid in along a second direction (direction \textcircled{2}), which is opposite to the first direction (direction \textcircled{1}). In an embodiment, the electronic device 200 may transition to the first state, which is the slide-in state, as at least a portion of the second housing 220 is accommodated in at least a portion of a first space 2101 formed through the first housing 210. In an embodiment, the electronic device 200 may transition to the second state, which is the slide-out state, as at least a portion of the second housing 220 moves outward (e.g., in direction \textcircled{1}) from the first space 2101. In an embodiment, in the slide-out state, the electronic device 200 may include a support member (e.g., the support member 240 in FIG. 4) (e.g., a bendable member, a multi-joint hinge module, a multi-bar assembly, a support bar assembly, or multiple bars), which at least partially forms the same plane as at least a portion of the second housing 220, and in the slide-in state, is at least partially accommodated in the first space 2101 of the first housing 210 in a bending manner. In an embodiment, at least a portion of the flexible display 230 may be disposed to be supported by at least a portion of the second housing 220. In an embodiment, the remaining portion of the flexible display 230 may be disposed to be at least partially supported by the support member 240 (e.g., the support member 240 in FIG. 4). In an embodiment, the support member (e.g., the support member 240 in FIG. 4) may be disposed in a manner of being attached to the rear surface of the flexible display 230. In an embodiment, in the slide-in state, at least a portion of the flexible display 230 may be accommodated into the first space 2101 of the first housing 210 in a bending manner while being supported by the support member (e.g., the support member 240 in FIG. 4), thereby being disposed to be invisible from the outside. In an embodiment, in the slide-out state, at least a portion of the flexible display 230 may be disposed to be visible from the outside while being supported by the support member (e.g., the support member 240 in FIG. 4), which at least partially forms the same plane as the second housing 220.

According to various embodiments, the first housing 210 may include a first side surface member 211, and the second housing 220 may include a second side surface member 221. In an embodiment, the first side surface member 211 may be disposed at the bottom side of the electronic device 200 and may include a first side surface 2111 having a first length, a second side surface 2112 extending in a perpendicular direction (e.g., the y-axis direction) from one end of the first side surface 2111 and having a second length, and a third side surface 2113 extending parallel to the second side surface 2112 from the other end of the first side surface 2111 and having the second length. In an embodiment, the first side surface member 211 may be at least partially made of a conductive member (e.g., metal). In some embodiments, the first side surface member 211 may be formed by a coupling a conductive member and a non-conductive member (e.g., polymer). In an embodiment, the first housing 210 may include a first extension member 212 extending from at least a portion of the first side surface member 211 to at least a portion of the first space 2101. In an embodiment, the first extension member 212 may be integrated with the first side surface member 211. In some embodiments, the first extension member 212 may be provided separately from the first side surface member 211 and structurally coupled to the first side surface member 211.

According to various embodiments, the second side surface member 221 may be disposed at the upper side of the electronic device 200 and may include a fourth side surface 2211 having a third length, a fifth side surface 2212 extending in a perpendicular direction (e.g., the −y-axis direction) from one end of the fourth side surface 2211 to correspond to the second side surface 2112 and having a fourth length, and a sixth side surface 2213 extending in a direction parallel to the fifth side surface 2212 from the other end of the fourth side surface 2211 to correspond to the third side surface 2113 and having the fourth length. In an embodiment, the second side surface member 221 may be at least partially made of a conductive member (e.g., metal). In some embodiments, the second side surface member 221 may be formed by coupling a conductive member and a non-conductive member (e.g., polymer). In an embodiment, at least a portion of the second side surface member 221 may include a second extension member 222 extending to at least a portion of a second space 2201 in the second housing 220. In an embodiment, the second extension member 222 may be integrated with the second side surface member 221. In some embodiments, the second extension member 222 may be provided separately from the second side surface member 221 and structurally coupled to the second side surface member 221.

According to various embodiments, the second side surface 2112 and the fifth side surface 2212 may be slidably coupled to each other. In an embodiment, the third side surface 2113 and the sixth side surface 2213 may be slidably coupled to each other. In an embodiment, in the slide-in state, a portion of the fifth side surface 2212 may overlap the second side surface 2112, thereby being disposed to be substantially invisible from the outside. In an embodiment, in the slide-in state, the remaining portion of the fifth side surface 2212 may be disposed to be visible from the outside. In some embodiments, in the slide-in state, the fifth side surface 2212 may overlap the second side surface 2112, thereby being disposed to be substantially invisible from the outside. In an embodiment, in the slide-in state, a portion of the sixth side surface 2213 may overlap the third side surface 2113, thereby being disposed to be substantially invisible from the outside. In an embodiment, in the slide-in state, the remaining portion of the sixth side surface 2213 may be disposed to be visible from the outside. In some embodiments, in the slide-in state, the sixth side surface 2213 may overlap the third side surface 2113, thereby being disposed to be substantially invisible from the outside. In an embodiment, a portion of the second extension member 222 may be disposed to be visible from the outside in the slide-in state. In some embodiments, in the slide-in state, the second extension member 222 may overlap the first extension member 212, thereby being disposed to be substantially invisible from the outside.

According to various embodiments, the first housing 210 may include a first rear surface cover 213 coupled to at least a portion of the first side surface member 211. In an embodiment, the first rear surface cover 213 may be disposed to be coupled to at least a portion of the first extension member 212. In some embodiments, the first rear cover 213 may be integrated with the first side surface member 211. In an embodiment, the first rear cover 213 may be made of a polymer, coated or colored glass, ceramic, metal (e.g., aluminum, stainless steel (STS), or magnesium), or a combination of at least two of these materials. In some embodiments, the first rear surface cover 213 may extend to at least a portion of the first side surface member 211. In some embodiments, the first rear surface cover 213 may be omitted, and at least a portion of the first extension member 212 may replace the first rear surface cover 213.

According to various embodiments, the second housing 220 may include a second rear surface cover 223 coupled to at least a portion of the second side surface member 221. In an embodiment, the second rear surface cover 223 may be disposed by being coupled to at least a portion of the second extension member 222. In an embodiment, the second rear surface cover 223 may be integrated with the second side surface member 221. In an embodiment, the second rear surface cover 223 may be made of polymer, coated or tinted glass, ceramic, metal (e.g., aluminum, stainless steel (STS), or magnesium), or a combination of at least two of these materials. In some embodiments, the second rear surface cover 223 may extend to at least a portion of the second side surface member 221. In some embodiments, the second rear surface cover 223 may be omitted, and at least a portion of the second extension member 222 may replace the second rear surface cover 223. In some embodiments, the second extension member 222 may be omitted, and the second rear surface cover 223 may replace the second extension member 222. In an embodiment, the second housing 220 may include a window cover 224 disposed at least partially on the second rear surface cover. In an embodiment, the window cover 224 may be disposed in an area exposed to the outside of the second housing 220 in the slide-in state and may be made of a material that facilitates the detection of the external environment through at least one camera module 216 and/or sensor module 217 disposed in the internal space 2201 of the second housing 220. For example, the window cover 224 may be made of glass and/or a polymer material in which at least an area corresponding to the camera module 216 and/or the sensor module 217 is formed to be transparent. In some embodiments, the electronic device 200 may further include a cover member 2111a disposed to cover at least a portion of the first side surface 2111 of the first housing 210.

According to various embodiments, the flexible display 230 may include a first portion 230a (e.g., a flat portion) that is always visible from the outside, and a second portion 230b (e.g., a bendable portion or a bending portion) that extends from the first portion 230a and is at least partially bent and accommodated into the first space 2101 of the first housing 210 to be invisible from the outside in the slide-in state. In an embodiment, at least a portion of the first portion 230a may be disposed to be supported by the second housing 220, and the remaining portion of the first portion 230a and the second portion 230b may be disposed to be at least partially supported by a support member (e.g., the support member 240 in FIG. 4). In an embodiment, in the state in which the second housing 220 is slid out along the first direction (direction \textcircled{1}), the second portion 230b of the flexible display 230 may form substantially the same plane as the first portion 230a while being supported by the support member (e.g., the support member 240 in FIG. 4), and may be disposed to be visible from the outside. In an embodiment, in the state in which the second housing 220 is slid in along the second direction (direction \textcircled{2}), the second portion 230b of the flexible display 230 may be accommodated into the first space 2101 of the first housing 210 in a bending manner and may be disposed to be invisible from the outside. Accordingly, the display area of the flexible display 230 may be variable as the second housing 220 is moved in a sliding manner from the first housing 210 along a predetermined direction (e.g., the +y-axis direction).

According to various embodiments, the flexible display 230 may have a first display area (e.g., an area corresponding to the first portion 230a) in the slide-in state (e.g., the first state). In an embodiment, when the second housing 220 transitions to the slide-out state (e.g., the second state), in which the second housing 220 moves by a first length L1 (e.g., a sliding stroke) with respect to the first housing 210, in the flexible display 230, a second display area (e.g., an area corresponding to the second portion 230b) corresponding to the first length L1 may be additionally secured in addition to the first display area. For example, when the flexible display 230 transitions from the slide-in state to the slide-out state, the display area may be expanded.

According to various embodiments, the electronic device 200 may include at least one of an input device (e.g., a microphone 203-1) disposed in the second space 2201 of the second housing 220, a sound output device (e.g., a phone call receiver 206 and/or a speaker 207), sensor modules 204 and 217, a camera module (e.g., the first camera module 205 or the second camera module 216), a connector port 208, a key input device 219, or an indicator (not illustrated). In an embodiment, the electronic device 200 may include another input device (e.g., the microphone 203) disposed in the first housing 210. In some embodiments, the electronic device 200 may be configured such that at least one of the above-mentioned components is omitted or other components are additionally included. In some embodiments, at least one of the above-mentioned components may be disposed in the first space 2101 of the first housing 210.

According to various embodiments, the input device may include a microphone 203-1. In some embodiments, the input device (e.g., the microphone 203-1) may include a plurality of microphones arranged to detect the direction of sound. The sound output device may include, for example, a call receiver 206 and a speaker 207. According to an embodiment, regardless of the slide-in/slide-out state, the speaker 207 may face the outside through at least one speaker hole provided in the second housing 220 at a position always exposed to the outside (e.g., in the fourth side surface 2211). In an embodiment, in the slide-out state, the connector port 208 may face the outside through a connector port hole provided in the second housing 220. In an embodiment, the connector port 208 may be covered so as to be invisible from the outside in the slide-in state. In some embodiments, in the slide-in state, the connector port 208 may face the outside through an opening provided in the first housing 210 to correspond to the connector port hole. In some embodiments, the call receiver 206 may include a speaker that operates without a separate speaker hole (e.g., a piezo speaker).

According to various embodiments, the sensor modules 204 and 217 may generate electrical signals or data values corresponding to an internal operating state or an external environmental state of the electronic device 200. In an embodiment, the sensor modules 204 and 217 may include, for example, a first sensor module 204 (e.g., a proximity sensor or an illuminance sensor) disposed on the front surface of the electronic device 200 and/or a second sensor module 217 (e.g., a heart rate monitoring (HRM) sensor) disposed on the rear surface of the electronic device 200. In an embodiment, the first sensor module 204 may be disposed under the flexible display 230 in the front surface of the electronic device 200. In an embodiment, the first sensor module 204 and/or the second sensor module 217 may include at least one of a proximity sensor, an illuminance sensor, a time-of-flight (TOF) sensor, an ultrasonic sensor, a fingerprint recognition sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, or a humidity sensor.

According to various embodiments, the camera module may include a first camera module 205 disposed on the front surface of the electronic device 200 and a second camera module 216 disposed on the rear surface of the electronic device 200. In an embodiment, the electronic device 200 may include a flash (not illustrated) positioned near the second camera module 216. In an embodiment, the camera modules 205 and 216 may include one or more lenses, an image sensor, and/or an image signal processor. In an embodiment, the first camera module 205 may be disposed under the flexible display 230 and may be configured to capture a subject through a portion of an active area (e.g., a display area) of the flexible display 230.

According to various embodiments, the first camera module 205 among the camera modules and the first sensor module 204 among the sensor modules 204 and 217 may be disposed to detect the external environment through the flexible display 230. For example, the first camera module 205 or the first sensor module 204 may be disposed in the second space 2201 in the second housing 220 to be in contact with the external environment through a transmissive area or a perforated opening provided in the flexible display 230. In an embodiment, the area of the flexible display 230 that faces the first camera module 205 may be configured as the transmissive area having a predetermined transmittance, as a portion of an active area that displays content. In an embodiment, the transmissive area may have a transmittance ranging from about 5% to about 20%. The transmission area may include an area overlapping an effective area (e.g., a field of view area) of the first camera module 205 through which light imaged by an image sensor to generate an image passes. For example, the transmissive area of the flexible display 230 may include an area having a lower pixel density and/or a lower wire density than the surrounding area. For example, the above-mentioned opening may replace the transmissive area. For example, some camera modules 205 may include an under-display camera (UDC). In some embodiments, some sensor modules 204 may be disposed to perform the functions thereof in the second space 2201 in the second housing 220 without being visually exposed through the flexible display 230.

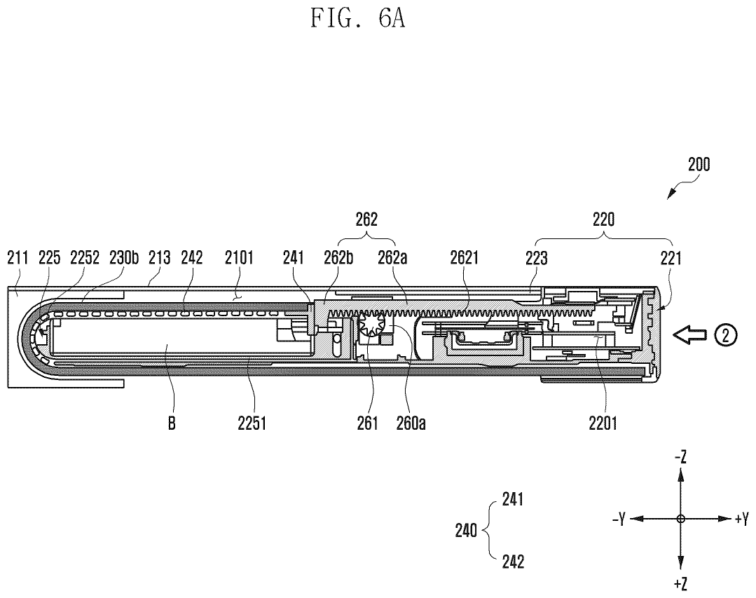

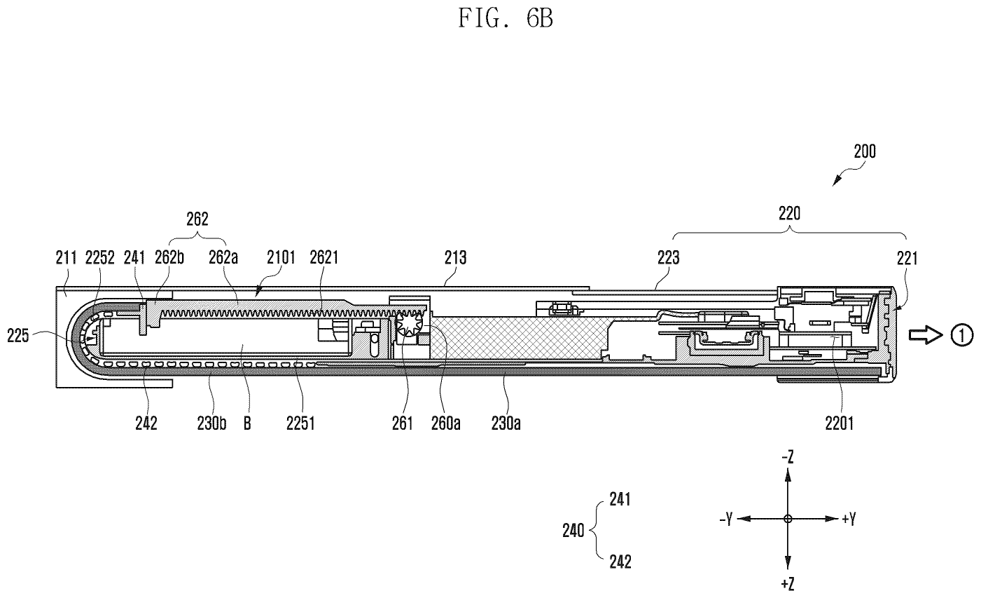

According to various embodiments, the slide-in operation and/or slide-out operation of the electronic device 200 may be automatically performed. For example, the slide-in operation and/or slide-out operation of the electronic device 200 may be performed through gear engagement between a motor (e.g., a driving motor (the motor 260 of FIG. 4)), which includes a pinion gear (e.g., the pinion gear 261 of FIG. 6A) disposed in the second space 2201 of the second housing 220, and a rack gear (e.g., the rack gear 262 of FIG. 6A or a guide member), which is disposed in a first space 2101 of the first housing 210, extends at least partially into the second space 2201, and is engaged with the pinion gear (e.g., the pinion gear 261 of FIG. 6A). For example, the processor (e.g., the processor 120 of FIG. 1) of the electronic device 200 may drive a driving motor (e.g., the motor 260 of FIG. 4) disposed inside the electronic device 200 when detecting a triggering signal for transitioning from the slide-in state to the slide-out state or from the slide-out state to the slide-in state. In an embodiment, the triggering signal may include a signal generated by the selection (e.g., touch) of an object displayed on the flexible display 230 or a signal generated by the operation (e.g., pressing) of a physical button (e.g., a key button) included in the electronic device 200.

According to various embodiments, the electronic device 200 has a structure in which the second housing 220 is slid in and/or slid out with respect to the first housing 210 along the length direction of the electronic device 200 (e.g., the vertical direction) (e.g., the ±y-axis direction), but is not limited thereto. For example, the electronic device 200 may have a structure in which the second housing 220 is slid in and/or slid out with respect to the first housing 210 along the width direction perpendicular to the length direction of the electronic device 200 (e.g., the horizontal direction) (e.g., the ±x-axis direction). In some embodiments, in the electronic device 200, the length of the first side surface 2111 of the first housing 210 may be greater than the length of the second side surface 2112. In this case, correspondingly, the length of the fourth side surface 2211 of the second housing 220 may also be greater than the length of the fifth side surface 2212.

FIG. 4 is an exploded perspective view of an electronic device according to an embodiment of the disclosure.

In describing the electronic device 200 of FIG. 4, components that are substantially the same as those of the electronic device 200 of FIGS. 2A to 3B may be assigned with the same reference numerals, and a detailed description thereof may be omitted.

Referring to FIG. 4, the electronic device 200 may include a first housing 210 including a first space 2101, a second housing 220 slidably coupled to the first housing 210 and including a second space 2201, a support member 240 (e.g., a bendable member, a support bar assembly, or a multi-bar assembly) fixed to at least a portion of the second housing 220 and at least partially accommodated in the first space 2101 in a bendable manner according to the slide-in operation, a flexible display 230 disposed to be supported by at least a portion of the support member 240 and the second housing 220, and a driver (e.g., a drive module or a drive mechanism) configured to drive the second housing 220 in the slide-in direction (e.g., the −y-axis direction) and/or the slide-out direction (e.g., the y-axis direction) from the first housing 210. In some embodiments, in the electronic device 200, the first housing 210 may be slidably coupled to the second housing 220 depending on the disposition position of the driver (e.g., the motor 260 and the rack gear 262). In an embodiment, the first housing 210 may include a first side surface member 211 and a first rear surface cover 213 (e.g., a first rear bracket) coupled to at least a portion of the first side surface member 211. In an embodiment, the first space 2101 may be defined by the coupling of the first side surface member 211 and the first rear surface cover 213. In an embodiment, the electronic device 200 may include a side surface cover 2211a (e.g., a dielectric cover) disposed on the fourth side surface 2211 of the second side surface member 221.

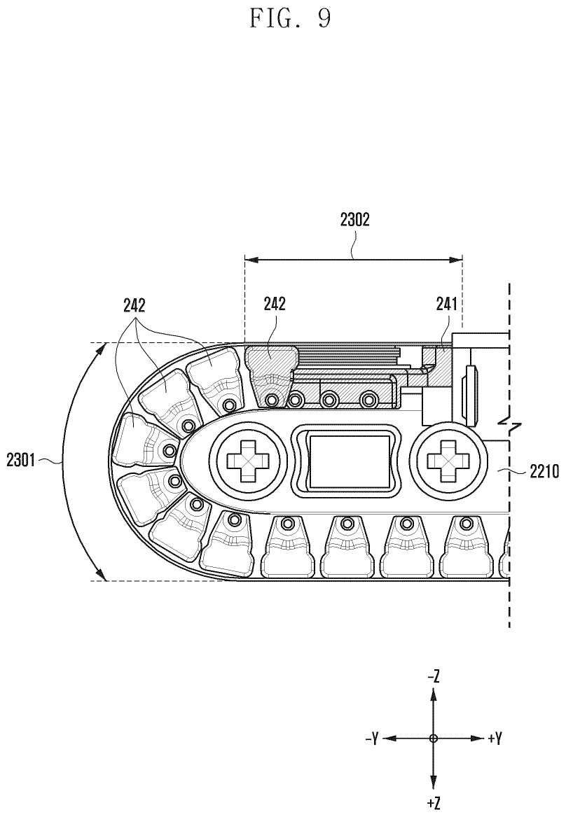

According to various embodiments, as illustrated in FIGS. 6A, 6B, and 9, the support member 240 may include a first support member 241 and a plurality of second support members 242. In an embodiment, the first support member 241 may be disposed at an end portion 231 of a second portion 230b of the flexible display 230, which is disposed in the first space 2101 of the first housing 210. For example, the first support member 241 may be disposed at an end portion 231 of an internal region of the second portion 230b of the flexible display 230, which is positioned in the first space 2101 of the first housing 210 regardless of whether the electronic device 200 is in the slide state or the slide-out state. The second support members 242 may be disposed at the remaining portion of the second portion 230b of the flexible display 230, excluding the end portion 231 of the second portion 230b where the first support member 241 is disposed, to support the flexible display 230. In an embodiment, at least some of the plurality of second support members 242 may be disposed in the first portion 230a of the flexible display 230.

According to various embodiments, the second housing 220 may include a second side surface member 221 and a second rear surface cover 223 (e.g., a second rear bracket or a window cover) coupled to at least a portion of the second side surface member 221. In an embodiment, the second space 2201 may be defined by the coupling of the second side surface member 221 and the second rear surface cover 223. In an embodiment, the second housing 220 may be coupled to the second side surface member 221 and may include a window cover 224 forming at least a portion of the rear surface of the second housing 220.

According to various embodiments, the driver (e.g., a drive module) may be disposed in the first space 2201 and may include a motor 260 including a pinion gear (e.g., the pinion gear 261 of FIG. 6A) and a rack gear 262 disposed to be gear-engaged with the pinion gear 261, fixed to a support bracket 225 disposed in the first space 2101, and extending from the first space 2101 to the second space 2201. In an embodiment, the electronic device 200 may further include a speed reduction module (e.g., a reduction gear assembly) structurally coupled to the driving motor so as to reduce the rotational speed and increase the driving force by being engaged with the motor 260. In an embodiment, the motor 260 may be disposed in the first space 2101 of the first housing 210 to be supported by at least a portion of the first side surface member 211 and/or the support bracket 225 (e.g., the second extension member 222 of FIG. 6A). In an embodiment, the motor 260 may be disposed to be supported by a motor bracket (e.g., the motor bracket 260a of FIG. 6A) fixed to the support bracket 225. In some embodiments, the rack gear 262 may be guided in the sliding direction (e.g., the ty-axis direction) through the motor bracket 260a. Accordingly, when the electronic device 200 is assembled, the pinion gear (e.g., the pinion gear 261 of FIG. 6A) may remain in a gear-engaged state with the rack gear 262, and as the pinion gear 261, which receives a driving force from the motor 260, moves along the rack gear 262, the first housing 210 may move in the slide-in direction (e.g., the +y-axis direction) or the slide-out direction (e.g., the −y-axis direction) with respect to the second housing 220.

According to various embodiments, the electronic device 200 may include a support bracket 225 fixed in the first space 2101 of the first housing 210. In an embodiment, the electronic device 200 may include a pair of guide rails 226 (e.g., a linear motion (LM) guide) that are fixed to both sides of the support bracket 225 to guide both ends of the support member 240 in the sliding direction while simultaneously guiding the second housing 220 in the sliding direction. In an embodiment, the term “guide rail 226” may be replaced with any of the following terms: guide body, guide fixing portion, or first guide portion. In an embodiment, the support bracket 225 and the pair of guide rails 226 may be fixed to the first housing 210 through fastening members such as screws. In an embodiment, the support bracket 225 may include a battery seating portion (e.g., the battery seating portion 2251 of FIG. 6A) configured to accommodate a battery B and a support portion (e.g., the support portion 2252 of FIG. 6A) provided at one end of the battery seating portion 2251 to support the rear surface of the support member 240 that bends during the sliding operation of the second housing 220. In an embodiment, the support portion 2252 may have a curved outer surface to smoothly guide the support member 240. In an embodiment, the support bracket 225 and the guide rails 226 may be fixed in the first space 2101 of the first housing 210 through fastening members such as screws. In an embodiment, the electronic device 200 may further include a battery cover 2253 coupled to the support bracket 225 to cover the mounted battery B. In some embodiments, the battery cover 2253 may be omitted. In an embodiment, the rack gear 262 may extend in the direction of the second space 2201 on an outer surface of the support bracket 225 and may be fixed to the first support member 241, which supports an end portion 231 (e.g., an end portion of an internal region) of the second portion of the flexible display 230, by a fastening member such as a screw. In an embodiment, the end portion 231 of the second portion 230b of the flexible display 230 may always be positioned in the first space 2101 of the first housing 210 regardless of whether the electronic device 200 is in the slide-in state or the slide-out state. In an embodiment, the first support member 240 may be configured to support the end portion 231 of the second portion 230b of the flexible display 230 and may be disposed in the first space 2101 of the first housing 210 regardless of whether the electronic device 200 is in the slide-in state or the slide-out state. In an embodiment, in addition to being coupled to the first support member 241 by a fastening member such as a screw, the rack gear 262 may be integrated with the first support member 241.

According to various embodiments, the electronic device 200 may include at least one electrical component (or electronic component) disposed in the second space 2201. In an embodiment, the at least one electrical component may include a first substrate 251 (e.g., a substrate assembly or a main substrate) (e.g., stacked substrates). In some embodiments, the at least one electrical component may be disposed in the first space 2101 of the first housing 210.

According to various embodiments, the electronic device 200 may include a second substrate 252 (e.g., a sub-substrate) and an antenna member 253, which are disposed between a first extension member (e.g., first extension member 212 of FIG. 6A) and the first rear surface cover 213 in the first housing 210. In an embodiment, the second substrate 252 and the antenna member 253 may be disposed on at least a portion of the first extension member 212. In an embodiment, the second substrate 252 and the antenna member 253 may be electrically connected to the first substrate 251 via at least one electrical connection member (e.g., a flexible printed circuit board (FPCB) or a flexible RF cable (FRC)). In an embodiment, the antenna member 253 may include a multi-function coil or multi-function core (MFC) antenna configured to execute a wireless charging function, a neat field communication (NFC) function, and/or an electronic payment function. In some embodiments, the second substrate 252 and/or the antenna member 253 may extend from the first space 2101 to the second space 2201 and may be electrically connected to the first substrate 251 via a flexibly deformable flexible substrate (a flexible printed circuit board (FPCB) 290.

According to various embodiments, the electronic device 200 may include a pair of guide blocks 227 fixed to the second housing 220 and slidably coupled to a pair of guide rails 226. In an embodiment, a pair of guide blocks 227 may be coupled to the second side surface member 221. The term “guide blocks 227” may be replaced with any of the following terms: moving blocks, slide blocks, guide heads, guide moving portions, or second guide portions. In an embodiment, through the slidable coupling of the guide rails 226 and the guide blocks 227, the second housing 220 may be slid out from the first housing 210 by a specific distance (e.g., the first distance L1 of FIG. 3A).

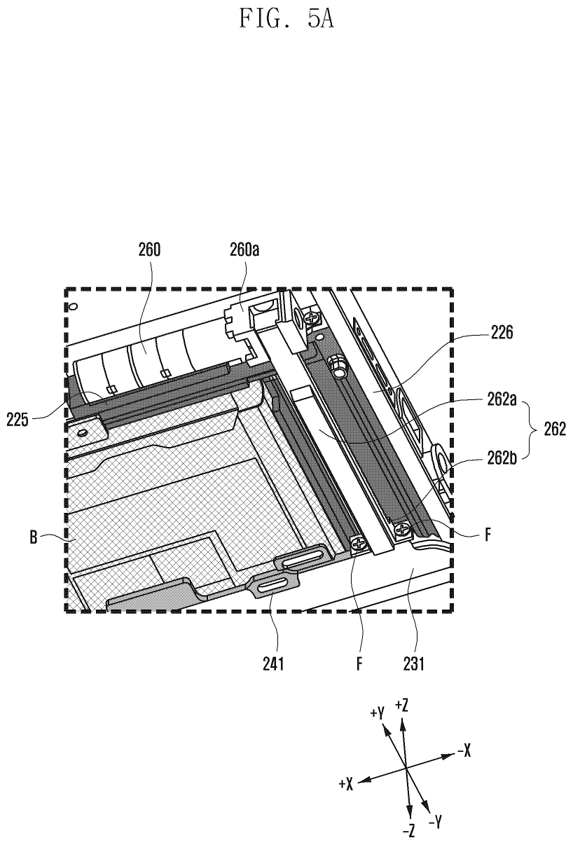

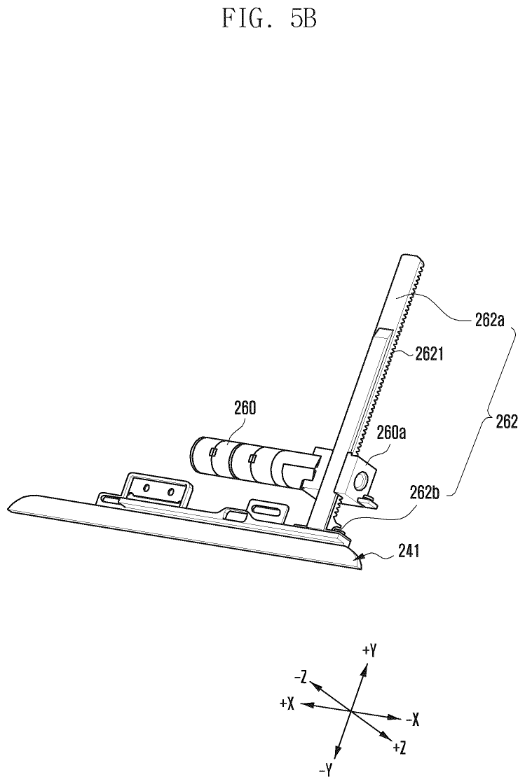

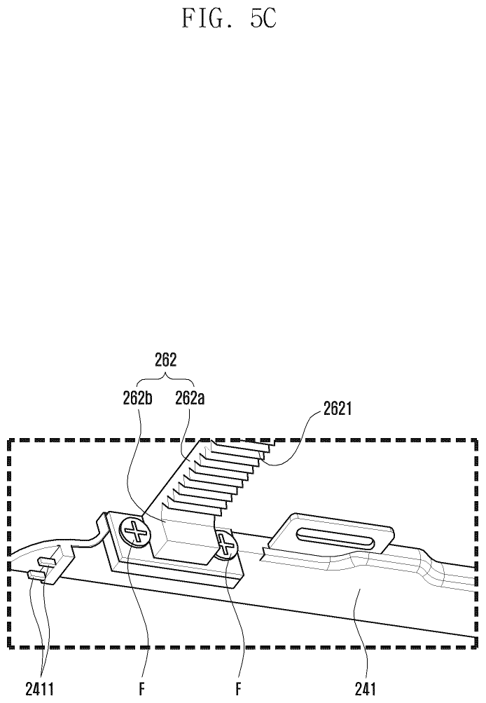

FIG. 5A is a view illustrating a state in which the rack gear coupled to the first support member supporting a second portion of the flexible display is connected to the pinion gear of the motor, according to an embodiment of the disclosure. FIG. 5B is a view illustrating a connection relationship among the first support member, the rack gear, and the motor, according to an embodiment of the disclosure. FIG. 5C is a view illustrating a coupling relationship between the first support member and the rack gear, according to an embodiment of the disclosure.

Referring to FIGS. 5A and 5B, the motor 260 may be inserted into a motor bracket 260a disposed at least partially in the first housing 210 (e.g., the support bracket 225 or the first side surface member 211) and may be engaged with the pinion gear 261 of the motor 260. In an embodiment, one end of the rack gear 262 may be coupled to the first support member 241 (e.g., an end bar) supporting the flexible display 230. In an embodiment, the first support member 241 may be disposed at an end portion 231 of an internal region of the second portion 230b of the flexible display 230, which is positioned in the first space 2101 of the first housing 210 regardless of whether the electronic device 200 is in the slide state or the slide-out state. In an embodiment, a portion of the rack gear 262 may be gear-engaged with the pinion gear 261 of the motor 260 and may move in the slide-out direction (e.g., direction \textcircled{1} in FIG. 3A) or the slide-in direction (e.g., direction \textcircled{2} in FIG. 2A) with respect to the second housing 220. In an embodiment, as the first support member 241 is coupled to the rack gear 262, the flexible display 230 may directly receive the driving force of the motor 260 via the rack gear 262 and may be slid into or slid out from the first space 2101 of the first housing 210. For example, as the first support member 241 is coupled to the rack gear 262, the flexible display 230 may receive the driving force of the motor 260 along with the rack gear 262 in the slide-out direction (direction \textcircled{1} or the slide-in direction (direction \textcircled{2}) with respect to the second housing 220. Accordingly, the flexible display 230 may receive the driving force from the motor 260 via the rack gear 262 and may be slid out from or slid into the first space 2101 of the first housing 210 based on the sliding operation of the electronic device 200.

According to an embodiment, as illustrated in FIG. 5A, the rack gear 262 may not be fixed to the first housing 210 and the second housing 220 but may be partially inserted into the motor bracket 260a and guided in the sliding direction (e.g., the +y-axis direction in FIG. 5A) through the motor bracket 260a.

Referring to FIGS. 5A, 5B, and 5C, the rack gear 262 may be substantially extended in the slide-out direction (direction \textcircled{1}) or the slide-in direction (direction 2) of the first housing 210 with respect to the second housing 220 (e.g., the Y-axis direction in FIG. 5A). In an embodiment, the rack gear 262 may include a first portion 230a engaged with the pinion gear 261 of the motor 260 and a second portion 230b extending from the first portion 230a and coupled to the first support member 241. In an embodiment, the first portion 230a may have teeth 2621 provided thereon to be engaged with the pinion gear 261. In an embodiment, the second portion 230b may be coupled to the first support member 241 by a fastening member F, such as a screw. In an embodiment, in addition to being coupled to the first support member 241 by the fastening member F, the rack gear 262 may be integrated with the first support member 241. In an embodiment, as the first portion 230a and the second portion 230b of the rack gear 262 extend in the slide-out direction (direction \textcircled{1}) or the slide-in direction (direction \textcircled{2}), the flexible display 230 may move in the same direction by the driving force of the motor 260 when viewed from above (e.g., in the −Z-axis direction of FIG. 5A).

FIG. 6A is a cross-sectional view of an electronic device taken along line 5a-5a in FIG. 2A according to an embodiment of the disclosure. FIG. 6B is a cross-sectional view of the electronic device taken along line 5b-5b of FIG. 3A, according to an embodiment of the disclosure.

In describing the electronic device 200 of FIGS. 6A and 6B, the same reference numerals are assigned to components that are substantially identical to those of the electronic device 200 of FIG. 4, and a detailed description thereof may be omitted.

Referring to FIGS. 6A and 6B, the electronic device 200 may include a first housing 210 having a first space 2101, a second housing 220 having a second space 2201, a support member 240 connected to the second housing 220 and at least partially accommodated in the first space 2101 in a slide-in state, a flexible display 230 disposed to be supported by at least portion of the support member 240 and at least a portion of the second housing 220, a rack gear 262 fixed to a first support member 241 (e.g., an end bar) of the support member 240 and extending toward the second space 2201 of the second housing 220, and a motor 260 disposed in the first space 2101 of the first housing 210 and including a pinion gear 261 gear-engaged with the rack gear 262. In an embodiment, the motor 260 may automatically move the first housing 210 in the slide-out direction (direction \textcircled{1}) or the slide-in direction (direction \textcircled{2}) with respect to the second housing 220 through the gear engagement between the pinion gear 261 and the rack gear 262. In some embodiments, by changing the disposition of the motor 260 and the rack gear 262, the first housing 210 may be automatically moved in the slide-out direction (direction \textcircled{2}) or the slide-in direction (direction \textcircled{1}) from the second housing 220. In an embodiment, the first housing 210 may include a first side surface member 211 and a first rear surface cover 213 coupled to a first extension member 212 extending from the first side surface member 211. In an embodiment, the second housing 220 may include a second side surface member 221 and a second rear surface cover 223 coupled to a second extension member 222 extending from the second side surface member 221.

According to various embodiments, a portion of the second housing 220 may be accommodated in the first space 2101 of the first housing 210 in the slide-in state of the electronic device 200 (the state of FIG. 6A). In an embodiment, at least a portion of the flexible display 230 may be accommodated in the first space 2101 in a bending manner together with the support member 240, thereby being disposed to be invisible from the outside. In this case, a first display area of the flexible display 230 (e.g., the display area corresponding to the first portion 230a in FIG. 3A) may be exposed to the outside.

According to various embodiments, at least a portion of the second housing 220 may transition to the slide-out state in which the second housing is at least partially moved to the outside from the first housing 210 along the first direction (direction \textcircled{1}) through the driving of the motor 260. In an embodiment, in the slide-out state of the electronic device 200 (the state of FIG. 6B), the flexible display 230 may be supported by the support bracket 225 and may move together with the support member 240, thereby exposing the portion accommodated in the first space 2101 to be at least partially visible from the outside. In this case, in the flexible display 230, a second display area (e.g., a display area including the first portion 230a and the second portion 230b in FIG. 3A) that is greater than the first display area may be exposed to the outside.

According to an embodiment, the sliding stroke (e.g., the first distance L1 in FIG. 3A) in which the second housing 220 transitions from the slide-in state to the slide-out state may be determined based on the length of the rack gear 262. In an embodiment, the length of the rack gear 262 may be determined based on the distance from the support bracket 225 to an upper inner surface 221a of the second side surface member 211 forming the second space 2201 when the electronic device 200 is in the slide-in state. For example, when the distance from the support bracket 225 to the upper inner surface 221a of the second space 2201 decreases in the slide-in state, the length of the rack gear 262 may also decrease, and the sliding stroke of the second housing 220 may also decrease proportionally. In an embodiment, when the distance from the support bracket 225 to the upper inner surface 221a of the second space 2201 increases in the slide-in state, the length of the rack gear 262 may also increase, and the sliding stroke of the second housing 220 may also increase proportionally.

According to an embodiment, as described above, the sliding stroke (e.g., the first distance L1 in FIG. 3A) in which the second housing 220 transitions from the slide-in state to the slide-out state may be determined based on the length of the rack gear 262. In an embodiment, the length of the rack gear 262 may be determined based on the position of the motor 260 within the electronic device 200. In an embodiment, as illustrated in FIGS. 6A and 6B, in a case where the motor 260 is disposed in the support bracket 225 of the first housing 210, the sliding stroke in which the electronic device 200 transitions from the slide-in state (retracted state) to the slide-out state (extended state) may remain the same even if the length of the rack gear 262 relatively decreases compared to an embodiment where the motor 260 is disposed in the second housing 220 (e.g., the second side surface member 221). In summary, in an embodiment where the motor 260 is disposed in the first housing 210, the length of the rack gear 262 may be smaller than that in an embodiment where the motor 260 is disposed in the second housing 220. Accordingly, as the area occupied by the rack gear 262 in the internal space of the electronic device 200 decreases, the space for accommodating components may be expanded.

In an embodiment, the length of the rack gear 262 and/or the sliding stroke of the electronic device 200 (e.g., the first distance L1 in FIG. 3A) may be determined by the size of the battery B disposed in a battery seating portion 2251 of the support bracket 225. In some embodiments, the size of the battery B in the length direction of the electronic device 200 (e.g., the +Y-axis direction) may be determined based on the sliding stroke of the second housing 220. For example, when the sliding stroke of the second housing 220 is determined, the size of the battery B may be designed to be maximally expanded to correspond to the first space 2101, thereby contributing to an increase in the use period of the electronic device 200.

In an embodiment, the battery B and the rack gear 262 may have an arrangement structure in which they are positioned side by side without overlapping when a side surface of the first housing 210 (e.g., the second side surface 2112 or the third side surface 2113 of FIG. 3A) is viewed from the outside and when the flexible display 230 is viewed from above. Accordingly, the battery B may be designed to be maximally expanded to a size substantially equal to or similar to the width of the first housing 210 along the width direction (e.g., the ±X-axis direction) of the electronic device 200, thereby contributing to an increase in the use time of the electronic device 200.

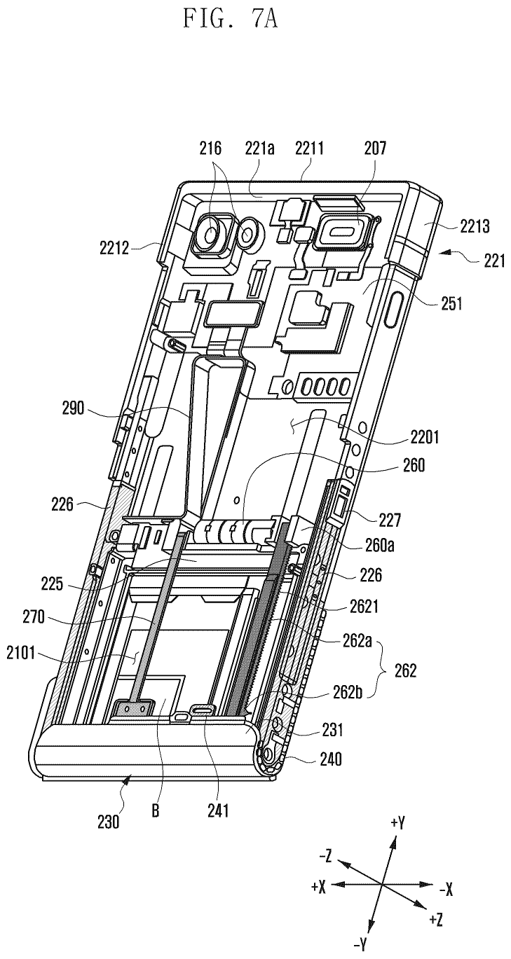

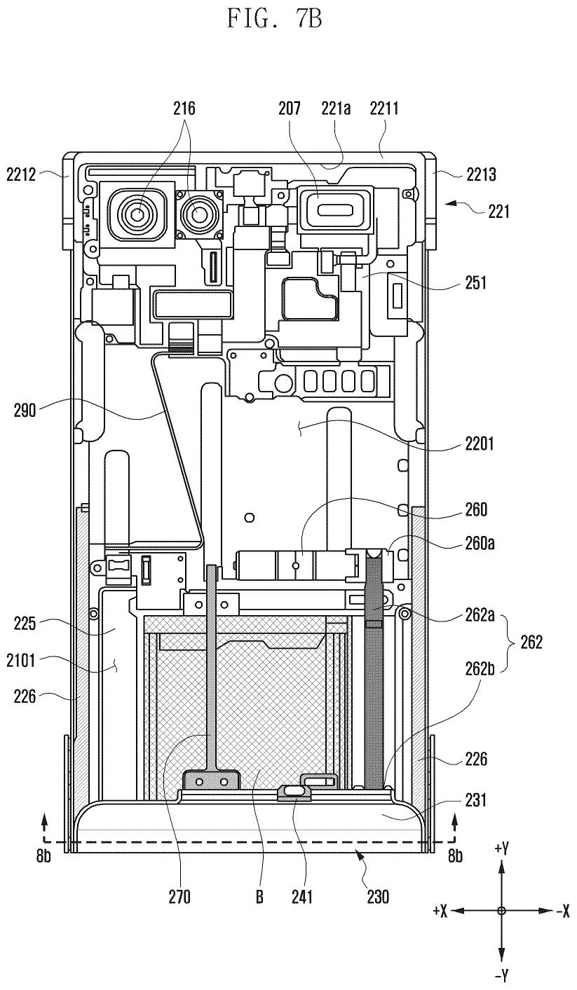

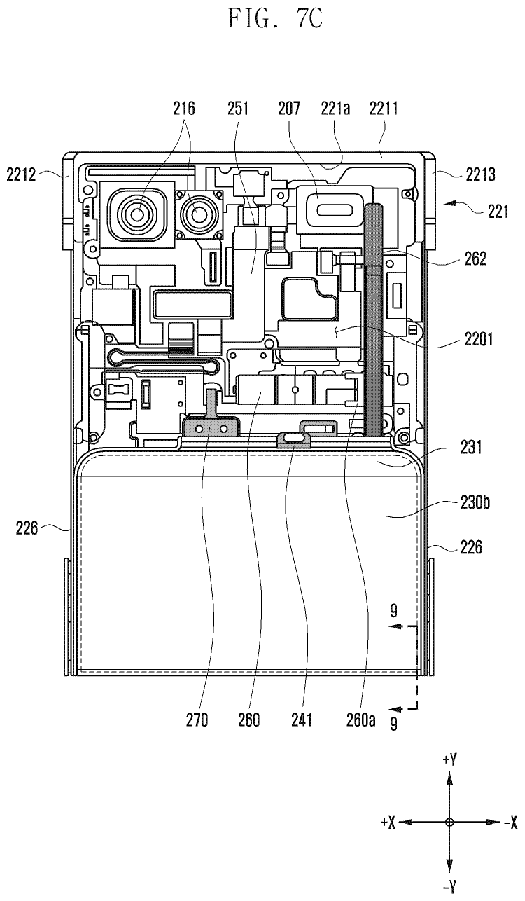

FIG. 7A is a perspective view illustrating the electronic device in the slide-out state according to an embodiments of the disclosure. FIG. 7B is a configuration view of the electronic device illustrating the arrangement structure of the motor and the rack gear disposed in the first housing in the slide-out state, according to an embodiment of the disclosure.

FIG. 7C is a configuration view of the electronic device illustrating the arrangement structure of the motor and the rack gear disposed in the first housing in the slide-in state, according to an embodiment of the disclosure.

Referring to FIGS. 7A to 7C, the motor 260 may be disposed in the support bracket 225. In an embodiment, the driving motor 260 control module 181 may control the operation of the motor 260 based on the electrical connection of the driving motor to the first substrate 251 (e.g., a substrate assembly or a main substrate) (e.g., stacked substrates) via a flexible substrate 290. In some embodiments, the motor 260 control module 181 may control the operation of the motor 260 when the motor 260 is electrically connected to a substrate disposed in the first housing 210.

According to an embodiment, as illustrated in FIGS. 7A to 7C, the motor 260 may be disposed in the motor bracket 260a, which is at least partially disposed in the first housing 210 (e.g., the support bracket 225 or the first side surface member 211) and may be disposed in the first space 2101 of the first housing 210. In an embodiment, one end of the rack gear 262 may be coupled to the first support member 241 of the support members 240. In an embodiment, the first support member 241 may be disposed at an end portion 231 of the second portion 230b of the flexible display 230 (e.g., an end portion 231 of the internal region) disposed in the first space 2101 of the first housing 210. In an embodiment, the end portion 231 of the second portion 230b of the flexible display 230 may be a portion positioned in the first space 2101 of the first housing 210 regardless of whether the electronic device 200 (e.g., the electronic device 101 of FIG. 1) is in the slide-in state (retracted state) or the slide-out state (extended state).

According to an embodiment, as illustrated in FIGS. 7A to 7C, a portion of the rack gear 262 may be gear-engaged with the pinion gear 261 of the motor 260 and may move in the slide-out direction (e.g., direction \textcircled{1} in FIG. 6B) or the slide-in direction (e.g., direction \textcircled{2} in FIG. 6A) with respect to the second housing 220. In an embodiment, as the first support member 241 is coupled to the rack gear 262, the flexible display 230 may directly receive the driving force of the motor 260 via the rack gear 262 and may be slid into or slid out from the first space 2101 of the first housing 210. For example, as the first support member 241 is coupled to the rack gear 262, the flexible display 230 may receive the driving force of the motor 260 along with the rack gear 262 in the slide-out direction (direction \textcircled{1}) or the slide-in direction (direction \textcircled{2}) with respect to the second housing 220. The guide protrusions 2411 protruding from both ends of the first support member 241 and the plurality of second support members 242 may be inserted into guide slits 2261 formed in the guide rails 226 and may move along the guide rails 226 fixed to the support bracket 225 based on the driving force of the motor 260 transmitted through the rack gear 262. As the guide protrusions 2411 of the support member 240 move along the guide slits 2261, the guide rails 226 may move with respect to the guide blocks 227 coupled to the first housing 210. Accordingly, as the support bracket 225, to which the guide rails 226 are fixed, moves in the slide-out direction (direction \textcircled{1}) or the slide-in direction (direction \textcircled{2} with respect to the second housing 220, the sliding operation of the electronic device 200 may be performed. In an embodiment, the support bracket 225, the guide rails 226, the motor 260, and the rack gear 262 may move in the same direction (e.g., the slide-out direction (direction \textcircled{1} or the slide-in direction (direction \textcircled{2})) with respect to the second housing 220.

In an embodiment, as the rack gear 262 directly moves the flexible display 230, the frictional force generated between the guide rails 226 and the guide protrusions 2411 of the support member 240 may be decreased, thereby decreasing the driving resistance generated during the sliding operation of the electronic device 200. For example, as the rack gear 262 extends in the sliding direction of the electronic device 200 (e.g., the Y-axis direction in FIG. 7A), the rack gear may decrease the strength of the repulsive force generated in the bending region 2301 of the second portion 230b of the flexible display 230 by being coupled to the first support member 241. Accordingly, the frictional force generated between the guide rails 226 and the guide protrusions 2411 of the support member 240 may be decreased, thereby decreasing the driving resistance generated during the sliding operation of the electronic device 200.

According to an embodiment, referring to FIGS. 7A and 7B, at least a portion of the rack gear 262 may be disposed in the first space 2101 of the first housing 210 when the electronic device 200 is in the slide-out state (extended state). For example, when the rear surface of the electronic device 200 is viewed from above (e.g., in the Z-axis direction of FIG. 7A), at least a portion of the rack gear 262 may overlap the support bracket 225. Referring to FIG. 7C, at least a portion of the rack gear 262 may be disposed in the second space 2201 of the second housing 220 when the electronic device 200 is in the slide-in state (retracted state). For example, when the rear surface of the electronic device 200 is viewed from above (e.g., in the Z-axis direction of FIG. 7C), at least a portion of the rack gear 262 may overlap the second side surface member 221 of the second housing 220.

According to an embodiment, the electronic device 200 may include at least one electronic component disposed in the second space 2201 of the second housing 220. In an embodiment, the at least one electronic component may include a substrate assembly 251 (e.g., a main substrate) disposed substantially in the central portion of the second space 2201. In an embodiment, the at least one electronic component may include at least one of a microphone 203-1, a first camera module 205, a second camera module 216, a receiver 206, a speaker 207, a connector port 208, or an array antenna, which are disposed around the substrate assembly 251.

In an embodiment, the rack gear 262 may be positioned to be in contact with or proximate to the upper inner surface 221a of the second space 2201 when the electronic device 200 is in the slide-in state. Accordingly, the rack gear 262 may have an overlapping structure that overlaps at least one electrical component (e.g., the substrate assembly 251) disposed in the second space 2201 when the rear surface of the electronic device is viewed from above. Various embodiments of the disclosure may provide an efficient stacking structure to reduce an increase in the thickness of the electronic device 200 resulting from the overlapping arrangement of the rack gear 262 and one or more electrical components (e.g., an electronic component). In an embodiment, some of the one or more electrical components may be disposed in an area that does not overlap the rack gear 262 when the second rear surface cover 223 is viewed from above. In an embodiment, the microphone 203-1, the first camera module 205, the second camera module 216, the receiver 206, the speaker 207, the connector port 208, or the array antenna may be disposed in the second space 2201 so as not to overlap the rack gear 262. In this case, the arrangement positions of the one or more electrical components may be changed.

According to an embodiment, as illustrated in FIG. 7C, the motor 260 may be disposed in the support bracket 225 of the first housing 210 so as not to overlap the second portion 230b of the flexible display 230 when the electronic device 200 is in the slide-in state. For example, in the slide-in state of the electronic device 200, the motor 260 may not be covered by the second portion 230b of the flexible display 230. In such a case, the motor 260 may not overlap a support member (e.g., the first support member 241 and the second support member 242) that supports at least a portion of the second portion 230b of the flexible display 230.

According to an embodiment, as illustrated in FIGS. 7A to 7C, in an embodiment, the rack gear 262 may extend in the same direction as the moving direction of the first housing 210 with respect to the second housing 220 (e.g., the Y-axis direction in FIG. 7A) and may be eccentrically disposed with respect to a virtual straight line passing through the central portion of the electronic device 200 (e.g., a line extending along the Y-axis direction in FIG. 7A). For example, as illustrated in FIG. 7A, the rack gear 262 may be eccentrically disposed in the −X direction with respect to the virtual straight line. In some embodiments, the rack gear 262 may be eccentrically disposed in the +X direction with respect to the virtual straight line, as illustrated in FIG. 7A. In some embodiments, the rack gear 262 may be disposed at the center (e.g., a centrally symmetrical position) of the support bracket 225 so as to extend across the center of the electronic device 200 along the sliding direction of the first housing 210 (e.g., the +Y-axis direction in FIG. 7A). For example, the rack gear 262 may be disposed to at least partially overlap the imaginary straight line extending across the central portion of the electronic device 200 (e.g., the line extending along the Y-axis direction in FIG. 7A) when the flexible display 230 is viewed from above. Such a central arrangement may reduce an increase in driving resistance caused by the eccentricity of the rack gear 262 during the sliding operation of the electronic device 200, thereby reducing the current consumption of the motor 260.

According to an embodiment, as illustrated in FIGS. 7A to 7C, the electronic device 200 may include at least one driving belt 270 (e.g., a lifespan belt or a tension belt) to support the flexible display 230 and to reduce the lifting of the flexible display 230 by providing uniform tension during operation. In an embodiment, the driving belt may help reduce the driving resistance caused by the eccentricity of the second housing 220, which is moved by the driving of the motor 260. In an embodiment, one end of the driving belt 270 may be fixed to the first support member 241 that supports the end portion 231 of the second portion 230b of the flexible display 230, and the other end may be coupled to at least a portion of the support bracket 225 of the first housing 210. In an embodiment, the driving belt 270 may be disposed to be wound around at least one rotation roller (not illustrated) rotatably disposed in the support bracket 225. In an embodiment, when the first housing transitions from the slide-in state to the slide-out state with respect to the second housing 220, one end of the driving belt 270 may move with respect to the other end of the driving belt 270, which is fastened to the support bracket 225, along the first support member 241 in the −Y-axis direction of FIG. 7A. The other end of the driving belt 270 fastened to the support bracket 225 may move with respect to the one end of the driving belt 270 in the +Y-axis direction of FIG. 7A. The driving belt 270 may help improve the surface quality of the flexible display 230 by ensuring that the flexible display 230 remains taut even during the sliding operation.

According to an embodiment, the electronic device 200 may include a magnetic member (e.g., a magnet) (not illustrated) and a Hall sensor (not illustrates) configured to detect the magnetic field strength of the magnetic member. In an embodiment, the magnetic member may be disposed in one of the first housing 210 and the second housing 220. For example, the magnetic member may be disposed in the support bracket 225 or the first side surface member 211 of the first housing 210, and the Hall sensor may be disposed in the second side surface member 221 of the second housing 220. Conversely, the magnetic member may be disposed in the second side surface member 221 of the second housing 220, and the Hall sensor may be disposed in the support bracket 225 or the first side surface member 211 of the first housing 210. In an embodiment, the Hall sensor may be disposed in the remaining one of the first housing 210 and the second housing 220 to detect the magnetic flux of the magnetic member during the sliding operation of the electronic device 200, thereby measuring the sliding stroke of the electronic device 200 (e.g., the first length L1 in FIG. 3A). In an embodiment, magnetic flux values according to the slide-in state, slide-out state, and an intermediate state (e.g., the intermediate state between the slide-in state and the slide-out state) of the electronic device 200 may be matched and stored in the memory (e.g., the memory 130 of FIG. 1). The processor (e.g., the processor 120 in FIG. 1) may identify the magnetic flux value detected by the Hall sensor and determine the relative position of the second housing 220 relative to the first housing 210 to determine the sliding state of the electronic device 200 (e.g., slide-in state (retracted state), slide-out state (extended state), or the intermediate state).

According to an embodiment, the processor 120 may determine that the electronic device 200 is in the slide-out state based on the magnetic flux value of the magnetic member detected by the Hall sensor and may slide the first housing 210 into the second space 2201 of the second housing 220 by a predetermined distance. For example, when the electronic device 200 is in the slide-out state, the processor 120 may control the motor 260 to move the rack gear 262 toward the second space 2201 of the second housing 220 by a predetermined distance stored in the memory 130. As the first support member 241 is coupled to the rack gear 262, the flexible display 230 may receive the driving force of the motor 260 via the rack gear 262 and may be slid into the first space 2101 of the first housing 210. In this case, the phenomenon of a portion of the flexible display 230 (e.g., the first portion 230a and/or a portion of the second portion 230b), which is viewed from the exterior of the electronic device 200, becoming crumpled when the electronic device 200 is in the slide-out state may be improved. Accordingly, the surface quality of the flexible display 230, which is viewed from the exterior of the electronic device 200, may be improved.

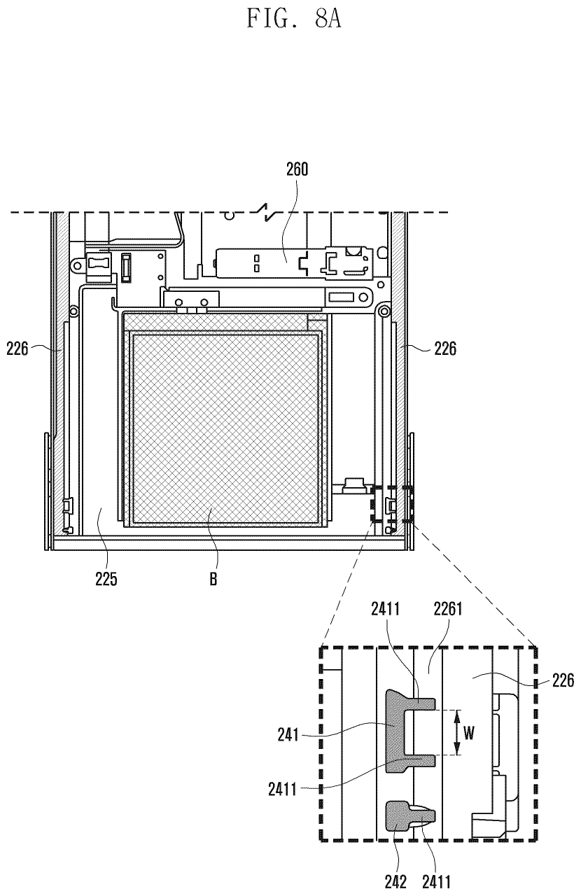

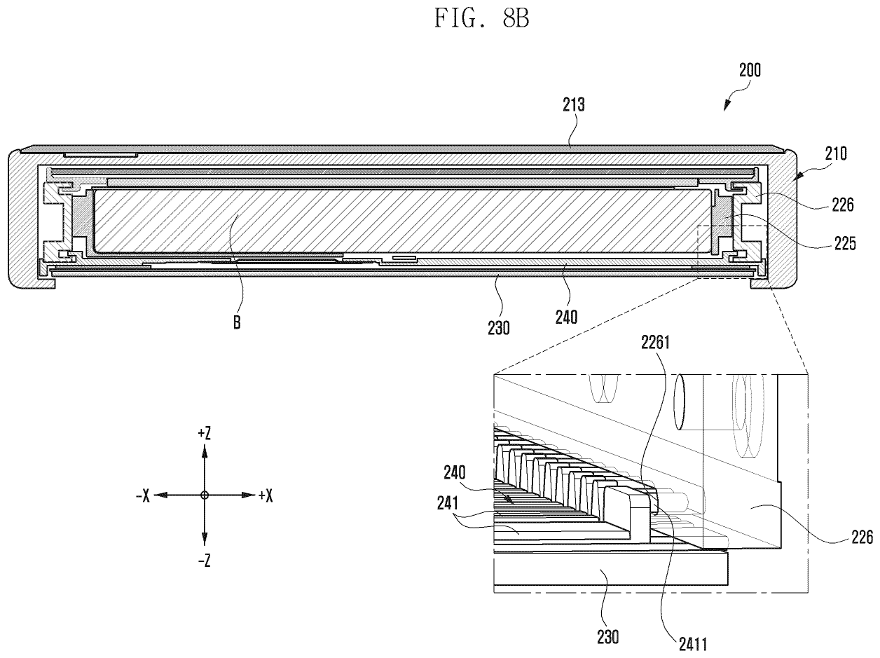

FIG. 8A is an enlarged view of guide protrusions inserted into a guide rail, according to an embodiment of the disclosure. FIG. 8B is a cross-sectional view of the electronic device taken along line 8b-8b of FIG. 7B, according to an embodiment of the disclosure.

Referring to FIGS. 8A and 8B, the support member 240 may be guided by the guide rail 226 during slide-in and slide-out operations. In an embodiment, the support member 240 may include guide protrusions 2411 protruding from both ends. In an embodiment, the guide rails 226 may each include a guide slit 2261 provided at a position corresponding to a movement trajectory of the support member 240. In an embodiment, when the support member 240 fixed by being attached to the rear surface of the flexible display 230 is movably coupled to the guide rails 226, the guide protrusions 2411 may move along the guide slits 2261, thereby helping to reduce a phenomenon in which the flexible display 230 is separated or deformed during operation.

According to an embodiment, as illustrated in FIG. 8A, the rack gear 262 may be eccentrically disposed in the −X-axis direction of FIG. 8A with respect to a virtual straight line passing through the central portion of the electronic device 200 (e.g., the electronic device 101 of FIG. 1). In this case, as the first support member 241 is coupled to the rack gear 262, the flexible display 230 may flow in the X-axis direction during the sliding operation of the electronic device 200 due to stress applied in the −X direction with respect to the central portion of the electronic device 200 by the rack gear 262. Conversely, when the rack gear 262 is eccentrically disposed in the +X-axis direction with respect to the central portion of the electronic device 200, the flexible display 230 may flow in the +X-axis direction during the sliding operation of the electronic device 200 due to stress applied in the +X-axis direction with respect to the central portion of the electronic device 200 by the rack gear 262. According to an embodiment of the disclosure, the rack gear 262 may be eccentrically disposed with respect to the central portion of the electronic device 200. In this case, the interval W between the guide protrusions 2411 of the first support member 241 may be designed to be wider than in the embodiment where the rack gear 262 is disposed in the central portion of the electronic device 200. As the interval W between the guide protrusions 2411 of the first support member 241 increases, the flow of the flexible display 230 during the sliding operation of the electronic device 200 may be improved or prevented.

FIG. 9 is a cross-sectional view of the electronic device taken along line 9-9 of FIG. 7C, according to an embodiment of the disclosure.

According to an embodiment, the second portion 230b of the flexible display 230 may include a bending region 2301, where at least a portion is bent based on the movement of the second housing 220 with respect to the first housing 210 or the movement of the first housing 210 with respect to the second housing 220, and a flat region 2302 positioned in the first space 2101 in the slide-out state of the electronic device 200 (e.g., the electronic device 101). In an embodiment, the first support member 241 and a second support member 242 adjacent to the first support member 241 among the plurality of second support members 242 may be disposed in the flat region 2302 of the flexible display 230. According to an embodiment, the interval between the first support member 241 and the second support member 242 that is adjacent to the first support member 241 among the plurality of second support members 242 may degrade the surface quality of the second portion 230b of the flexible display 230. For example, during the sliding operation of the first housing 210 with respect to the second housing 220, at least a portion of the flexible display 230 may become crumpled due to the gap between the first support member 241 and the second support member 242 adjacent to the first support member 241. According to an embodiment of the disclosure, as illustrated in FIG. 9, the second support member 242 that is adjacent to the first support member 241 among the plurality of second support members 242 may be integrated with or coupled to the first support member 241. Accordingly, as the interval between the first support member 241 and the second support member 242 that is adjacent to the first support member 241 is eliminated or reduced, the deterioration in surface quality caused by the interval between the first support member 241 and the second support member 242 may be improved or prevented in the flexible display 230.

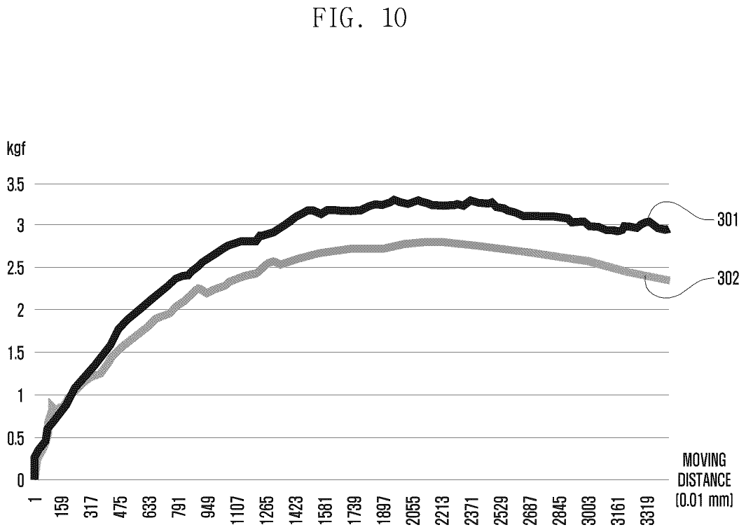

FIG. 10 is a diagram illustrating the frictional force between the guide rail and the guide protrusions during the relative movement of the first housing and the second housing, according to an embodiment of the disclosure.

According to an embodiment, a first graph 301 illustrated in FIG. 10 may represent the driving resistance of the electronic device 200 (e.g., the electronic device 101) according to the movement distance of the flexible display 230 during the sliding operation of the electronic device 200 in an embodiment where the motor 260 is disposed in the second housing 220 and the rack gear 262 is coupled to the first housing 210. The second graph 302 may represent the driving resistance of the electronic device 200 according to the movement distance of the flexible display 230 during the sliding operation of the electronic device 200 in an embodiment where the rack gear 262 is coupled to the first support member 241 and gear-engaged with the pinion gear 261 of the motor 260 disposed in the support bracket 225, as described with reference to FIGS. 4, 5A, 5B, 5C, 6A, 6B, 7A, 7B, 7C, 8A, 8B, and 9.

In an embodiment, in the embodiment corresponding to the first graph 301, the second portion 230b of the flexible display 230 may include a bending region 2301 that at least partially bends according to the sliding operation of the electronic device 200. The flexible display 230 may experience a repulsive force in the bending region 2301 that acts to restore the display to its unfolded state. In an embodiment, the guide protrusions 2411 inserted into the guide slits 2261 may experience increased friction with the guide slits 2261 due to the repulsive force generated in the bending region 2301. The frictional force acting between the guide protrusions 2411 and the guide slits 2261 may increase the driving resistance generated during the sliding operation of the electronic device 200.

Meanwhile, in an embodiment corresponding to the second graph 302, the first support member 241 may be coupled to the rack gear 262 that is gear-engaged with the pinion gear 261 of the motor 260 or may be integrated with the rack gear 262. In an embodiment, at least a portion of the rack gear 262 may be inserted into the motor bracket 260a and gear-engaged with the pinion gear 261 of the motor 260. In an embodiment, as the rack gear 262 extends in the sliding direction of the electronic device 200 (e.g., the Y-axis direction in FIG. 7A), the rack gear may decrease the strength of the repulsive force generated in the bending region 2301 of the second portion 230b of the flexible display 230 by being coupled to the first support member 241. Accordingly, the frictional force acting between the guide protrusions 2411 and the guide slits 2261 during the sliding operation of the electronic device 200 may be reduced, thereby decreasing the driving resistance of the electronic device 200. Accordingly, as the driving resistance required for the sliding operation of the electronic device 200 is reduced, the power consumption of the motor 260 may be reduced, leading to improved driving efficiency and reduced noise. In addition, as the driving resistance of the electronic device 200 is reduced, the size of the motor 260 may be reduced. Accordingly, the reduction in the size of the motor 260 may provide additional space for component arrangement in the internal space of the electronic device 200, and the thickness of the electronic device 200 may be reduced.

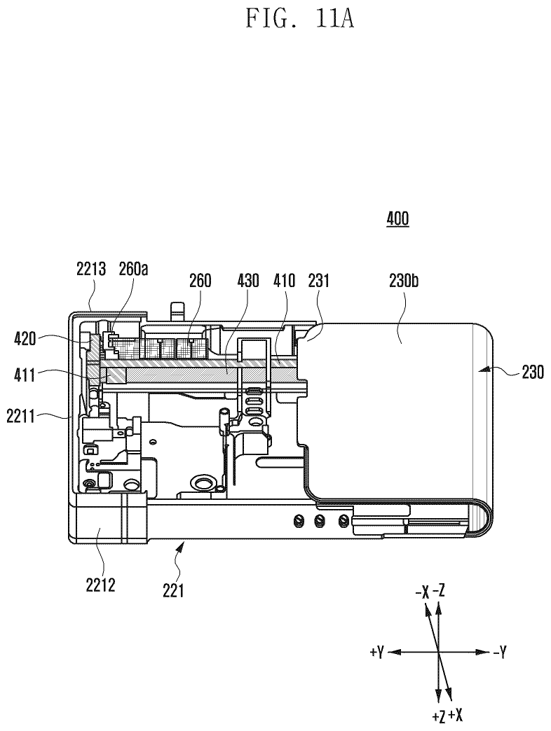

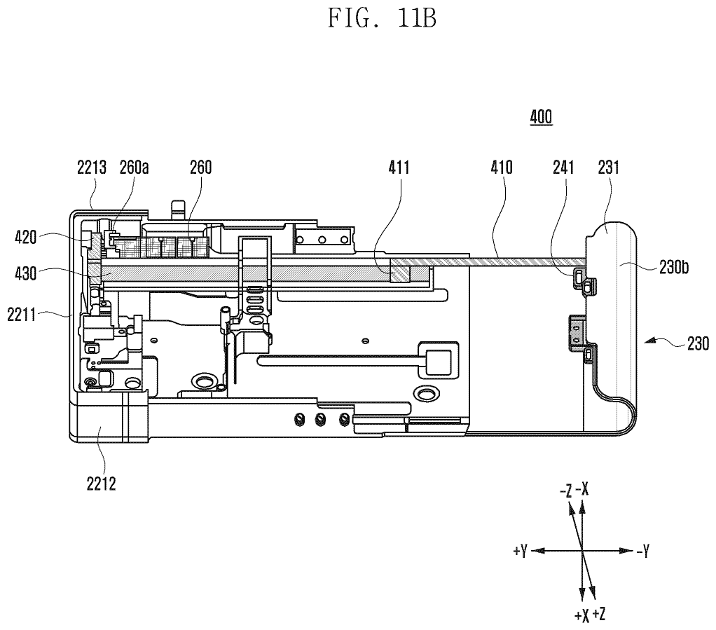

FIGS. 11A and 11B are views illustrating the connection relationship of the motor, the screw member, and the guide member coupled to the first support member, according to various embodiments of the disclosure.

In describing the electronic device 400 of FIGS. 11A and 11B, components that are substantially the same as those of the electronic device 200 of FIGS. 2A, 2B, 3A, 3B, 4, 5A, 5B, 5C, 6A, 6B, 7A, 7B, 7C, 8A, 8B, and 9 are given the same reference numerals, and a detailed description thereof may be omitted.

The electronic device 400 of FIGS. 11A and 11B (e.g., the electronic device 101 of FIG. 1, or the electronic device 200 of FIG. 2A) may omit the rack gear 262 described with reference to FIGS. 4, 5A, 5B, 5C, 6A, 6B, 7A, 7B, 7C, 8A, 8B, and 9 and may include a guide member 410 (e.g., a coupling structure) that is coupled to or integrated with the first support member 241. In an embodiment, the guide member 410 may extend along the moving direction of the second housing 220 with respect to the first housing 210 (e.g., the Y-axis direction in FIG. 11A). According to an embodiment, as illustrated in FIGS. 11A and 11B, the guide member 410 may include a fastening portion 411 (e.g., a nut) into which a screw member 430 is inserted. In an embodiment, the screw member 430 and the fastening portion 411 may have a male screw and a female screw, respectively. In an embodiment, the screw member 430 may rotate about the Y-axis of FIG. 11A based on the driving of the motor 260. In an embodiment, the screw member 430 may be fastened to an interlocking gear 420 gear-engaged with the pinion gear 261 of the motor 260 and may rotate about the Y-axis of FIG. 11A. In some embodiments, the screw member 430 may be directly gear-engaged with the pinion gear 261 of the motor 260. In an embodiment, based on the rotation of the screw member 430, the fastening portion 411 of the guide member 410 may move along the Y-axis of FIG. 11A with respect to the screw member 430. In an embodiment, as the first support member 241 is coupled to or integrated with the guide member 410, the flexible display 230 may directly receive the driving force of the motor 260 via the guide member 410. Accordingly, the flexible display 230 may be slid into or slid out from the first space 2101 of the first housing 210. For example, the flexible display 230 may receive the driving force of the motor 260 in the slide-out direction (e.g., direction 1 in FIG. 3A) or the slide-in direction (e.g., direction \textcircled{2} in FIG. 2A) with respect to the second housing 220 together with the guide member 410. Accordingly, as the flexible display 230 receives the driving force from the motor 260 via the guide member 410, the flexible display may be slid out from or slid into the first space 2101 of the first housing 210.

According to an embodiment, as illustrated in FIGS. 11A and 11B, at least a portion of the motor 260, the interlocking gear 420, and/or the screw member 430 may be disposed in the second housing 220 (e.g., the second side surface member 221). In some embodiments, at least a portion of the motor 260, the interlocking gear 420, and/or the screw member 430 may be disposed in the first housing 210 (e.g., the support bracket 225 and/or the first side surface member 211). According to an embodiment, when the electronic device 400 is in the slide-out state (extended state), at least a portion of the guide member 410 may be positioned in the first space 2101 of the first housing 210. For example, when the rear surface of the electronic device 400 is viewed from above (e.g., in the Z-axis direction of FIG. 11A), at least a portion of the guide member 410 may overlap the support bracket 225. When the electronic device 400 is in the slide-in state (retracted state), at least a portion of the guide member 410 may be disposed in the second space 2201 of the second housing 220. For example, when the rear surface of the electronic device 400 is viewed from above (e.g., in the Z-axis direction of FIG. 11A), at least a portion of the guide member 410 may overlap the second side surface member 221 of the second housing 220.

According to an embodiment, the guide member 410 extends in the sliding direction of the electronic device 400 (e.g., the Y-axis direction in FIG. 11A). Thus, the guide member 410 may reduce the strength of the repulsive force generated in the bending region 2301 of the second portion 230b of the flexible display 230 by being coupled to the first support member 241. Accordingly, the frictional force acting between the guide protrusions 2411 and the guide slits 2261 during the sliding operation of the electronic device 400 may be reduced, thereby decreasing the driving resistance of the electronic device 400. As the driving resistance required for the sliding operation of the electronic device 400 is reduced, the power consumption of the motor 260 may be reduced, leading to improved driving efficiency and reduced noise. In addition, as the driving resistance of the electronic device 400 is reduced, the size of the motor 260 may be reduced. Accordingly, the reduction in the size of the motor 260 may provide additional space for component arrangement in the internal space of the electronic device 400, and the thickness of the electronic device 400 may be reduced.

An electronic device 200 or 400 may include a rollable electronic device (e.g., a slidable electronic device) in which the display area of a flexible display 230 is expandable and/or contractible. The electronic device 200 or 400 may include a first housing 210 (e.g., a first housing structure, a moving structure, a slide housing, a slide bracket, or a slide structure) and a second housing 220 (e.g., a second housing structure, a fixed structure, a base housing, a base bracket, or a base structure) that are at least partially fitted together and are slidably coupled to each other. For example, the first housing 210 and the second housing 220 may be slidably operated relative to each other and support at least a portion of the flexible display 230 (e.g., an expandable display or a stretchable display) so as to guide the flexible display 230 to have a first display area in a slide-in state and a second display area greater than the first display area in a slide-out state.

The electronic device 200 or 400 may include, as driving module, a motor 260 (e.g., a motor) disposed in the internal space and having a pinion gear 261, and a rack gear 262 gear-engaged with the pinion gear 261. The motor 260 may automatically operate the second housing 220 to slide by a predetermined reciprocating distance with respect to the first housing 210, which is gripped by a user. For example, when the motor 260 is disposed in the first housing 210 or the second housing 220, the rack gear 262, which extends along the sliding direction and is gear-engaged with the pinion gear 261, may be disposed in the remaining housing.

The flexible display 230 may be supported by a plurality of support members 240 (e.g., multiple bars) attached to the rear surface thereof. The support members 240 may each have both ends inserted into the guide rails 226 (e.g., LM guides) of the electronic device 200 or 400. During the sliding operation of the electronic device 200 or 400, which is based on the driving force of the motor 260 transmitted via the rack gear 262, the support members 240 may move along the guide rails 226. Accordingly, based on the sliding operation of the electronic device 200 or 400, the flexible display 230 may be at least partially slid into the internal space (e.g., the first space 2101) or slid out from the internal space (e.g., the first space 2101) of the electronic device 200 or 400.

Meanwhile, driving resistance may be generated during the sliding operation of the electronic device 200 or 400. For example, the driving resistance may include the repulsive force that tends to unfold the flexible display 230 in the bending region 2301 as a portion of the flexible display 230 bends and is inserted into the internal space of the electronic device 200 or 400, the frictional force generated between the guide rails 226 and the support members 240 during the sliding operation of the electronic device 200 or 400, and the frictional force among various mechanical components constituting the electronic device 200 or 400 during the sliding operation. To transition the electronic device 200 or 400 between the slide-in state and the slide-out state, a driving force greater than the driving resistance may be required. As the driving resistance increases, the size of the motor 260 may need to be increased to provide a higher driving force. In this case, as the space occupied by the motor 260 within the internal space of the electronic device 200 or 400 increases, the space available for arranging electronic components may be reduced.

However, the problems that the disclosure seeks to solve are not limited to the aforementioned problems, and may be expanded in various ways without departing from the spirit and scope of the disclosure.

The technical problems to be addressed by the disclosure are not limited to those described above, and other technical problems may be clearly understood by a person ordinarily skilled in the related art to which the disclosure pertains.

According to an embodiment of the disclosure, an electronic device 101 or 200 may include a first housing 210, a second housing 220 configured to move with respect to the first housing, a flexible display 230 disposed between the first housing and the second housing, the flexible display including an internal region that at least partially moves within an internal space 2101 of the electronic device based on a movement of the second housing with respect to the first housing, a support member 240 including a first support member 241 supporting an end portion 231 of the internal region of the flexible display and a plurality of second support members 242 supporting a portion of the flexible display excluding the end portion, a motor 260 including a pinion gear 261 and disposed in the first housing, and a rack gear 262 engaged with the pinion gear and having an end coupled to the first support member. The rack gear and the first support member may move in the same direction as the moving direction of the first housing with respect to the second housing based on driving of the motor.

In an embodiment, the rack gear may include a first portion 262a engaged with the pinion gear of the motor and a second portion 262b extending from the first portion in a direction parallel to the moving direction of the first housing and coupled to the first support member. The first support member and the first and second portions of the rack gear may move in the same direction as the moving direction of the first housing with respect to the second housing based on the driving of the motor.

In an embodiment, the internal region of the flexible display may not overlap the motor when the flexible display is viewed from above.

In an embodiment, the electronic device may further include at least one electronic component disposed in the second housing. When the flexible display is viewed from above, the rack gear may overlap the electronic component in a slide-in state of the electronic device. When the flexible display is viewed from above, the rack gear may overlap the first housing in a slide-out state of the electronic device.

In an embodiment, the electronic device may further include a drive belt 270 having one end coupled to the first support member and the other end fastened to the first housing.

In an embodiment, the electronic device may further include a magnetic member disposed in one of the first housing and the second housing, a Hall sensor disposed in the remaining one of the first housing and the second housing, the Hall sensor facing the magnetic member based on the movement of the second housing with respect to the first housing, a processor 120 electrically connected to the Hall sensor, and memory 130 electrically connected to the processor. The processor may be configured to determine a relative position of the second housing with respect to the first housing using a magnetic flux value detected by the Hall sensor, and to control the motor to move the rack gear toward the second housing by a predetermined distance stored in the memory based on determining that the electronic device is in the slide-out state according to the magnetic flux value detected by the Hall sensor.

In an embodiment, the first support member and a second support member adjacent to the first support member may be integrated.

In an embodiment, the internal region of the flexible display may include a bending region 2301 that at least partially bends based on the movement of the second housing with respect to the first housing, and a flat region 2302 positioned in the internal space. The first support member and the second support member adjacent to the first support member may be disposed in the flat region.

In an embodiment, the moving distance L1 of the first housing with respect to the second housing may be determined based on the length of the rack gear.

In an embodiment, the rack gear may be positioned close to or in contact with an upper inner surface 221a of the second housing in a slide-in state of the electronic device.

In an embodiment, the rack gear may extend in the same direction as the moving direction of the first housing with respect to the second housing and may be disposed eccentrically with respect to a virtual straight line passing through the center of the electronic device.

In an embodiment, the rack gear may extend in the same direction as the moving direction of the first housing with respect to the second housing and may be at least partially overlap the virtual straight line passing through the center of the electronic device.

In an embodiment, the electronic device may include a guide rail 226 disposed in the first housing and configured to accommodate at least a portion of the support member to guide the movement of the support member, and a guide block 227 disposed in the second housing and coupled to the guide rail to be movable with respect to the guide rail in response to the movement of the second housing.

In an embodiment, the first housing may include a support bracket 225 in which the motor is disposed and which is coupled to the guide rail, and a side member 211 surrounding the support bracket and the guide rail.

According to an embodiment of the disclosure, an electronic device 101 or 400 may include a first housing 210, a second housing 220 configured to move with respect to the first housing, a flexible display 230 disposed between the first housing and the second housing, the flexible display including an internal region that at least partially moves within an internal space 2101 of the electronic device based on a movement of the second housing with respect to the first housing, a support member 240 including a first support member 241 supporting an end portion 231 of the internal region of the flexible display and a plurality of second support members 242 supporting a portion of the flexible display excluding the end portion, a motor 260 including a pinion gear 261 and disposed in the first housing, and a guide member 410 driven by the pinion gear and having an end coupled to the first support member. The guide member and the first support member may move in the same direction as the moving direction of the first housing with respect to the second housing based on driving of the motor.

In an embodiment, the electronic device may further include an interlocking gear 420 engaged with the pinion gear of the motor and a screw member 430 engaged with and driven by the interlocking gear, the screw member being screw-coupled to the guide member. The guide member may include a fastening portion 411 at one end thereof into which the screw member is inserted, and the guide member may move in the same direction as the moving direction of the first housing with respect to the second housing based on rotation of the screw member driven by the motor.

In an embodiment, the internal region of the flexible display may not overlap the motor when the flexible display is viewed from above.

In an embodiment, the electronic device may further include at least one electronic component disposed in the second housing. When the flexible display is viewed from above, the guide member may overlap the electronic component in a slide-in state of the electronic device, and when the flexible display is viewed from above, the guide member may overlap the first housing in a slide-out state of the electronic device.

In an embodiment, the electronic device may further include a driving belt connected to one end of the first support member and one end of the second housing, a magnetic member disposed in one of the first housing and the second housing, a Hall sensor disposed in the remaining one of the first housing and the second housing, the Hall sensor facing the magnetic member based on a movement of the second housing with respect to the first housing, a processor 120 electrically connected to the Hall sensor, and memory 130 electrically connected to the processor. The processor may be configured to determine a relative position of the second housing with respect to the first housing using a magnetic flux value detected by the Hall sensor, and to control the motor to move the guide member toward the second housing by a predetermined distance stored in the memory based on determining that the electronic device is in the slide-out state according to the magnetic flux value detected by the Hall sensor.

In an embodiment, the first support member and a second support member adjacent to the first support member may be integrated, and the internal region of the flexible display may include a bending region 2301 that at least partially bends based on the movement of the second housing with respect to the first housing, and a flat region 2302 positioned in the internal space when the electronic device is in the slide-out state. The first support member and the second support member adjacent to the first support member may be disposed in the flat region.

According to various embodiments of the disclosure, the electronic device 200 or 400 may include an end bar (e.g., the first support member 241) that supports an end portion 231 of an internal region of a flexible display 230 positioned in an internal space (e.g., the first space 2101) of the electronic device 200 or 400 in a slide-in state (retracted state) or a slide-out state (extended state). The electronic device 200 or 400 may include a guide member 410 (e.g., rack gear 262 or a coupling structure) configured to receive a driving force via a motor 260 and coupled to the end bar 241. The flexible display 230 may directly receive the driving force of the motor 260 via the guide member and may be slid into or slid out from the internal space 2101 of the electronic device 200 or 400. As the electronic device 200 or 400 directly moves the flexible display 230 via the guide member connected to the motor 260, the driving resistance may be reduced. For example, as the end bar 241 is coupled to the guide member, the repulsive force tending to unfold the flexible display 230 at the bending region 2301 may be reduced. Accordingly, as the driving resistance generated during the sliding operation of the electronic device 200 or 400 is reduced, the size of the motor 260 providing the driving force may be reduced. Thus, a space corresponding to the reduced size of the motor 260 may be additionally secured in the internal space of the electronic device 200 or 400 for arranging components.

Advantageous effects obtainable from the disclosure may not be limited to the above-mentioned effects, and other effects which are not mentioned may be clearly understood from the following descriptions by those skilled in the art to which the disclosure pertains.

It should be appreciated that various embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

It will be understood that, in addition to the above-disclosed embodiments, the disclosure also contemplates and includes embodiments based on combinations of any two or more of the above-disclosed embodiments and embodiments including any combination of the above-described features. That is, the absence of explicit an indication that two features may be combined or two embodiments may be combined does not mean that such combinations are not contemplated, but such combinations should be considered to be included herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a second housing configured to move with respect to the first housing;
a flexible display disposed between the first housing and the second housing, the flexible display including an internal region that at least partially moves within an internal space of the electronic device based on a movement of the second housing with respect to the first housing;
a support member including a first support member supporting an end portion of the internal region of the flexible display and a plurality of second support members supporting a portion of the flexible display excluding the end portion;
a motor including a pinion gear and disposed in the first housing; and
a rack gear engaged with the pinion gear and having an end coupled to the first support member,
wherein the rack gear and the first support member move in a same direction as a moving direction of the first housing with respect to the second housing based on driving of the motor.

2. The electronic device of claim 1,
wherein the rack gear includes a first portion engaged with the pinion gear of the motor and a second portion extending from the first portion in a direction parallel to the moving direction of the first housing and coupled to the first support member, and
wherein the first support member and the first and second portions of the rack gear move in the same direction as the moving direction of the first housing with respect to the second housing based on the driving of the motor.

3. The electronic device of claim 1, wherein the internal region of the flexible display does not overlap the motor when the flexible display is viewed from above.

4. The electronic device of claim 1, further comprising:
at least one electronic component disposed in the second housing,
wherein, when the flexible display is viewed from above, the rack gear overlaps the electronic component in a slide-in state of the electronic device, and
wherein, when the flexible display is viewed from above, the rack gear overlaps the first housing in a slide-out state of the electronic device.

5. The electronic device of claim 1, further comprising:
a drive belt having one end coupled to the first support member and another end fastened to the first housing.

6. The electronic device of claim 5, further comprising:
a magnetic member disposed in one of the first housing and the second housing;
a Hall sensor disposed in the other of the first housing and the second housing, the Hall sensor facing the magnetic member based on a movement of the second housing with respect to the first housing;
a processor electrically connected to the Hall sensor; and
memory electrically connected to the processor,
wherein the processor is configured to:
determine a relative position of the second housing relative to the first housing using a magnetic flux value detected by the Hall sensor, and
control the motor to move the rack gear toward the second housing by a predetermined distance stored in the memory based on determining that the electronic device is in a slide-out state according to the magnetic flux value detected by the Hall sensor.

7. The electronic device of claim 1, wherein the first support member and a second support member adjacent to the first support member are integrated.

8. The electronic device of claim 7,
wherein the internal region of the flexible display includes a bending region that at least partially bends based on the movement of the second housing relative to the first housing, and a flat region positioned in the internal space, and
wherein the first support member and the second support member adjacent to the first support member are disposed in the flat region.

9. The electronic device of claim 1, wherein a moving distance of the first housing with respect to the second housing is determined based on the length of the rack gear.

10. The electronic device of claim 1, wherein the rack gear is positioned close to or in contact with an upper inner surface of the second housing in a slide-in state of the electronic device.

11. The electronic device of claim 1, wherein the rack gear extends in the same direction as the moving direction of the first housing with respect to the second housing and is disposed eccentrically with respect to a virtual straight line passing through the center of the electronic device.

12. The electronic device of claim 1, wherein the rack gear extends in the same direction as the moving direction of the first housing with respect to the second housing and at least partially overlaps a virtual straight line passing through the center of the electronic device.

13. The electronic device of claim 1, further comprising:
a guide rail disposed in the first housing and configured to accommodate at least a portion of the support member to guide the movement of the support member; and
a guide block disposed in the second housing and coupled to the guide rail to be movable with respect to the guide rail in response to the movement of the second housing.

14. The electronic device of claim 13, wherein the first housing includes a support bracket in which the motor is disposed and which is coupled to the guide rail, and a side member surrounding the support bracket and the guide rail.

15. An electronic device comprising:
a first housing;
a second housing movably coupled to the first housing;
a flexible display disposed between the first housing and the second housing, the flexible display including an internal region that at least partially moves within an internal space of the electronic device based on a movement of the second housing with respect to the first housing;
a support member including a first support member supporting an end portion of the internal region of the flexible display and a plurality of second support members supporting a portion of the flexible display excluding the end portion;
a motor including a pinion gear and disposed in the first housing; and
a guide member driven via the pinion gear and having one end coupled to the first support member,
wherein the guide member and the first support member move in a same direction as a moving direction of the first housing with respect to the second housing based on a driving of the motor.

16. The electronic device of claim 15, further comprising:
a coupling gear engaged with the pinion gear of the motor; and
a screw member coupled to and driven by the coupling gear, the screw member being screw-coupled to the guide member,
wherein the guide member includes a fastening portion at one end thereof into which the screw member is inserted, and
wherein the guide member moves in a same direction as a moving direction of the first housing with respect to the second housing based on rotation of the screw member driven by the motor.

17. The electronic device of claim 15, wherein the internal region of the flexible display does not overlap the motor when the flexible display is viewed from above.

18. The electronic device of claim 15, further comprising:
at least one electronic component disposed in the second housing,
wherein, when the flexible display is viewed from above, the guide member overlaps the electronic component in a slide-in state of the electronic device, and
wherein, when the flexible display is viewed from above, the guide member overlaps the first housing in a slide-out state of the electronic device.

19. The electronic device of claim 15, further comprising:
a driving belt connected to one end of the first support member and one end of the second housing;
a magnetic member disposed in one of the first housing and the second housing;
a Hall sensor disposed in the other of the first housing and the second housing, the Hall sensor facing the magnetic member based on a movement of the second housing with respect to the first housing;
a processor electrically connected to the Hall sensor; and
memory electrically connected to the processor,
wherein the processor is configured to:
determine a relative position of the second housing relative to the first housing using a magnetic flux value detected by the Hall sensor, and
control the motor to move the guide member toward the second housing by a predetermined distance stored in the memory based on determining that the electronic device is in a slide-out state according to the magnetic flux value detected by the Hall sensor.

20. The electronic device of claim 15,
wherein the first support member and a second support member adjacent to the first support member are integrated,
wherein the internal region of the flexible display includes a bending region that at least partially bends based on the movement of the second housing with respect to the first housing, and a flat region positioned in the internal space when the electronic device is in a slide-out state, and
wherein the first support member and the second support member adjacent to the first support member are disposed in the flat region.
